(19) United States
(12) Patent Application Publication
(10) Pub. No.: US 2025/0322442 A1
(43) Pub. Date: Oct. 16, 2025

(54) METHODS, SYSTEMS, APPARATUSES, AND DEVICES FOR MANAGING SHOPPING OF PRODUCTS BY USERS

(71) Applicant: Salem Hassan, Jacksonville, FL (US)

(72) Inventor: Salem Hassan, Jacksonville, FL (US)

(21) Appl. No.: 18/739,027

(22) Filed: Jun. 10, 2024

Related U.S. Application Data
(60) Provisional application No. 63/632,375, filed on Apr. 10, 2024.

(51) Int. Cl. G06Q 30/0601

(52) U.S. Cl. CPC G06Q 30/0631

(57) ABSTRACT

A method of managing shopping of products by users includes transmitting a questionnaire for scoring the products for a user to a user device, receiving a response for the questionnaire from the user device, analyzing the response and the questionnaire, determining a preference associated with the user based on the analyzing of the response and the questionnaire, obtaining a product data, analyzing the product characteristic of each of the plurality of products, determining a degree of match for each of the plurality of products to the user, generating a product-preference score for each of the plurality of products, transmitting the product-preference score corresponding to each of the plurality of products and the product information of each of the plurality of products to the user device, and storing the preference.

### FIELD OF THE INVENTION

Generally, the present disclosure relates to the field of data processing. More specifically, the present disclosure relates to methods, systems, apparatuses, and devices for managing shopping of products by users.

### BACKGROUND OF THE INVENTION

The field of data processing is technologically important to several industries, business organizations, and/or individuals. In particular, the use of data processing is prevalent for managing shopping of products by users.

Existing techniques for managing shopping of products by users are deficient with regard to several aspects. For instance, current technologies do not score and rank products based on the requirements of users. As a result, a different technology is needed that scores products based on the requirements of the users. Furthermore, current technologies do not personalize online showrooms of products for users as well as provides the explanation behind the score, as to how the score equates to the product match for the user. As a result, a different technology is needed which allows for the creation of personalized online showrooms of the products for the users, that can be generated in an easy, one click showroom creation method, by the seller. Moreover, current technologies do not create profiles for users based on the requirements of the users associated with the products. As a result, a different technology is needed that allows the creation of the profiles of the users based on the requirements of the users.

Therefore, there is a need for improved methods, systems, apparatuses, and devices for managing shopping of products by users that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of managing shopping of products by users, in accordance with some embodiments. Accordingly, the method may include a step of transmitting, using a communication device, at least one questionnaire for scoring the products for at least one user to at least one user device associated with the at least one user. Further, the method may include a step of receiving, using the communication device, at least one response for the at least one questionnaire from the at least one user device. Further, the method may include a step of analyzing, using a processing device, the at least one response and the at least one questionnaire. Further, the method may include a step of determining, using the processing device, at least one preference associated with the at least one user based on the analyzing of the at least one response and the at least one questionnaire. Further, the method may include a step of obtaining, using the processing device, at least one product data associated with each of a plurality of products providable to the at least one user. Further, the at least one product data may include at least one product information and at least one product characteristic of each of the plurality of products. Further, the method may include a step of analyzing, using the processing device, the at least one product characteristic of each of the plurality of products based on the at least one preference. Further, the method may include a step of determining, using the processing device, a degree of match for each of the plurality of products to the at least one user based on the analyzing of the at least one product characteristic. Further, the degree of match ranges from a minimum degree of match and a maximum degree of match. Further, the method may include a step of generating, using the processing device, a product-preference score for each of the plurality of products based on the degree of match. Further, the method may include a step of transmitting, using the communication device, the product-preference score corresponding to each of the plurality of products and the at least one product information of each of the plurality of products to the at least one user device. Further, the method may include a step of storing, using a storage device, the at least one preference.

Further disclosed herein is a system for managing shopping of products by users, in accordance with some embodiments. Accordingly, the system may include a communication device configured for transmitting at least one questionnaire for scoring the products for at least one user to at least one user device associated with the at least one user. Further, the communication device may be configured for receiving at least one response for the at least one questionnaire from the at least one user device. Further, the communication device may be configured for transmitting a product-preference score corresponding to each of a plurality of products and at least one product information of each of the plurality of products to the at least one user device. Further, the system may include a processing device communicatively coupled with the communication device. Further, the processing device may be configured for analyzing the at least one response and the at least one questionnaire. Further, the processing device may be configured for determining at least one preference associated with the at least one user based on the analyzing of the at least one response and the at least one questionnaire. Further, the processing device may be configured for obtaining at least one product data associated with each of the plurality of products providable to the at least one user. Further, the at least one product data may include the at least one product information and at least one product characteristic of each of the plurality of products. Further, the processing device may be configured for analyzing the at least one product characteristic of each of the plurality of products based on the at least one preference. Further, the processing device may be configured for determining a degree of match for each of the plurality of products to the at least one user based on the analyzing of the at least one product characteristic. Further, the degree of match ranges from a minimum degree of match and a maximum degree of match. Further, the processing device may be configured for generating the product-preference score for each of the plurality of products based on the degree of match. Further, the system may include a storage device communicatively coupled with the processing device. Further, the storage device may be configured for storing the at least one preference.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flowchart of a method 200 for managing shopping of products by users, in accordance with some embodiments.

FIG. 3 is a flowchart of a method 300 for managing shopping of products by users, in accordance with some embodiments.

FIG. 4 is a flowchart of a method 400 for managing shopping of products by users, in accordance with some embodiments.

FIG. 5 is a flowchart of a method 500 for managing shopping of products by users, in accordance with some embodiments.

FIG. 6 is a flowchart of a method 600 for managing shopping of products by users, in accordance with some embodiments.

FIG. 7 is a flowchart of a method 700 for managing shopping of products by users, in accordance with some embodiments.

FIG. 8 is a flowchart of a method 800 for managing shopping of products by users, in accordance with some embodiments.

FIG. 9 is a flowchart of a method 900 for managing shopping of products by users, in accordance with some embodiments.

FIG. 10 is a block diagram of a system 1000 for managing shopping of products by users, in accordance with some embodiments.

FIG. 11 is a block diagram of the system 1000 for managing shopping of products by the users, in accordance with some embodiments.

FIG. 12 is a flowchart of a method 1200 for facilitating managing vehicles for users, in accordance with some embodiments.

FIG. 13 is a flowchart of a method 1300 for facilitating personalized shopping of vehicles, in accordance with some embodiments.

FIG. 14 is a flow diagram of a method 1400 for facilitating personalized shopping of vehicles, in accordance with some embodiments.

FIG. 15 is a continuation flow diagram of the method 1400 for facilitating the personalized shopping of the vehicles, in accordance with some embodiments.

FIG. 16 is a continuation flow diagram of the method 1400 for facilitating the personalized shopping of the vehicles, in accordance with some embodiments.

FIG. 17 is a screenshot of a user interface 1700 of an application for facilitating personalized shopping of vehicles, in accordance with some embodiments.

FIG. 18 is a screenshot of a user interface 1800 of the application for facilitating the personalizing shopping of the vehicles, in accordance with some embodiments.

FIG. 19 is a screenshot of a user interface 1900 of the application for facilitating the personalizing shopping of the vehicles, in accordance with some embodiments.

FIG. 20 is a screenshot of a user interface 2000 of the application for facilitating the personalizing shopping of the vehicles, in accordance with some embodiments.

FIG. 21 is a screenshot of a user interface 2100 of the application for facilitating the personalizing shopping of the vehicles, in accordance with some embodiments.

FIG. 22 is a screenshot of a user interface 2200 of the application for facilitating the personalized shopping of the vehicles, in accordance with some embodiments.

FIG. 23 is a screenshot of a user interface 2300 of the application for facilitating the personalized shopping of the vehicles, in accordance with some embodiments.

FIG. 24 is a continuation screenshot of the user interface 2300 of the application for facilitating the personalized shopping of the vehicles, in accordance with some embodiments.

FIG. 25 is a screenshot of a user interface 2500 of the application for facilitating the personalized shopping of the vehicles, in accordance with some embodiments.

FIG. 26 is a flow diagram of an Integrated Shopper Crowd Surveying (ISCS) 2600 for facilitating personalized shopping of vehicles, in accordance with some embodiments.

FIG. 27 is a block diagram of a dynamic survey response viewer 2700 for facilitating personalized shopping of vehicles, in accordance with some embodiments.

FIG. 28 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for managing shopping of products by users, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating personalized shopping of vehicles.

Further, the present disclosure describes an application for facilitating personalized shopping of vehicles. Further, the application may be Vehiscore. Further, the Vehiscore consists of two main components.

Further, one of the two main components includes Consumer Vehiscore Match Shopping Tool. Further, the Vehiscore is a new methodology for improving the vehicle shopping experience for consumers. When shopping in the searchshop marketplace for a vehicle, a consumer can take a short quiz which will then result in the searchshop site assigning a score (vehiscore) to each of the vehicles available for sale in the marketplace. The higher the score, the better the match. At any time while shopping in the marketplace, the shopper can click on the vehiscore badge available on the vehicle detail page, to see a window open that explains why the vehicle was scored as such. This includes displaying the list of vehicle attributes that are well matched to the shopper (as well as what it lacks). Also, after the shopper completes the vehiscore quiz, they will then see a widget displayed in the top header near their profile account icon. By clicking on this vehiscore widget in the header, shoppers can go there to:
Edit their questions and answers to update their vehicle preferences
Access an easy slider bar that allows them to adjust the range of the vehiscore to apply to the vehicles presented to them in the marketplace. For example, if they only want to see vehicles that are a 90% match or more, they can filter the results to only show results that have a minimum score of 90%. As they adjust their progress bar to filter results, they see in real-time the number of results that match the score range. This allows them to dynamically adjust the range based on how many results they pick up as they slide the progress bar.

Further, the second main component includes the Dealer Vehiscore Sales Shopping Tool. Further, the Vehiscore is also a sales tool for dealers. When dealers log in to their searchshop dealer dashboard, they use this tool to see new prospects that are shopping in the marketplace and have completed vehiscore profiles that match inventory that the dealer has available for sale. The dealer can then create a personalized online vehiscore showroom with the vehicles that are a good match for the shopper and email a link to that showroom, with the sales rep and dealership contact information, as well as the actual vehicles with their match scores. It's a tool for dealers to better cater to the changing behaviors of consumers as they shift more towards online shopping.

Further, the present disclosure describes a system for facilitating personalized shopping of vehicles. Further, the system may include a communication device, a processing device, and a storage device. Further, the communication device may be configured for receiving at least one request from at least one user device associated with at least one user. Further, the communication device may be configured for transmitting at least one question to the at least one user device. Further, the communication device may be configured for receiving at least one response associated with the at least one question from the at least one user device. Further, the communication device may be configured for transmitting at least one vehicle identifier and at least one compatibility score to the at least one user device. Further, the processing device may be communicatively coupled with the communication device. Further, the processing device may be configured for generating the at least one question based on the at least one request. Further, the processing device may be configured for obtaining at least one data associated with at least one vehicle based on the at least one request. Further, the processing device may be configured for analyzing the at least one response and the at least one data. Further, the processing device may be configured for generating the at least one compatibility score for the at least one vehicle based on the analyzing of the at least one data and the at least one response. Further, the storage device may be communicatively coupled with the processing device. Further, the storage device may be configured for storing the at least one compatibility score and the at least one vehicle identifier of the at least one vehicle corresponding to the at least one compatibility score.

Further, in some embodiments, the communication device may be configured for transmitting at least one prompt to the at least one user device. Further, the communication device may be configured for receiving at least one second response associated with the at least one prompt from the at least one user device. Further, the communication device may be configured for transmitting at least one option to the at least one user device. Further, the communication device may be configured for receiving at least one selection corresponding to the at least one option from the at least one user device. Further, the communication device may be configured for transmitting at least one profile to at least one second user device associated with at least one second user. Further, the processing device may be configured for analyzing the at least one response. Further, the processing device may be configured for generating the at least one profile associated with the at least one user based on the analyzing of the at least one response. Further, the processing device may be configured for generating the at least one prompt. Further, the processing device may be configured for determining an allowance to share the at least one profile based on the at least one second response. Further, the processing device may be configured for generating the at least one option for selecting a second user using at least one criterion based on the allowance to share the at least one profile. Further, the processing device may be configured for identifying the at least one second user based on the at least one selection.

Further, the present disclosure describes a solution to content filtration by quizzing a user and capturing responses of the user corresponding to questions to personalize content for the user by assigning scores to the content. Further, the scores indicate a preference of the user for the content. Further, the content may be associated with products.

Further, the solution to content filtration may include dynamically adjusting questions in a questionnaire for quizzing the user. The question in the questionnaire is identified by a location type of a location of the user and a product usage type of a product use by the user.

Further, the present disclosure describes a method for facilitating surveying of users shopping for products. Further, the method may include transmitting, using a communication device, at least one question for facilitating the shopping of the products for at least one user to at least one device. Further, the at least one device may be configured for presenting the at least one question to the at least one user. Further, the at least one question may be associated with a quiz. Further, the method may include obtaining, using a processing device, at least one response information associated with the at least one user in real time. Further, the method may include analyzing, using the processing device, the at least one response information in real time. Further, the method may include generating, using the processing device, at least one preference information of at least one preference of the at least one user related to the products in real time based on the analyzing. Further, the method may include transmitting, using the communication device, the at least one preference information to the at least one device. Further, the at least one device may be configured for presenting the at least one preference information in real time.

Further, the present disclosure describes a method for facilitating a dynamic presentation of responses associated with a survey for users. Further, the method may include capturing, using at least one capturing device (such as sensors), at least one information associated with at least one preference of at least one user related to products in real time. Further, the method may include analyzing, using a processing device, the at least one information. Further, the method may include transforming, using the processing device, the at least one information based on the analyzing. Further, the method may include generating, using the processing device, a multimedia content for the at least one preference in real time based on the transforming. Further, the multimedia content may include images, graphs, animation, voice, etc. Further, the method may include transmitting, using the communication device, the multimedia content to at least one device. Further, the at least one device is configured for presenting the multimedia content in real time.

Further, the present disclosure describes an integrated shopper crowd surveying. Further, the integrated shopper crowd surveying includes generating (e.g. using quiz among other ways) and displaying real-time information relating to consumer preferences (e.g. simple display).

Further, the present disclosure describes a dynamic survey response viewer. Further, the dynamic survey response viewer may be associated with capturing and displaying rich (images, graphs, animation, voice, etc.), real-time information relating to preferences of users.

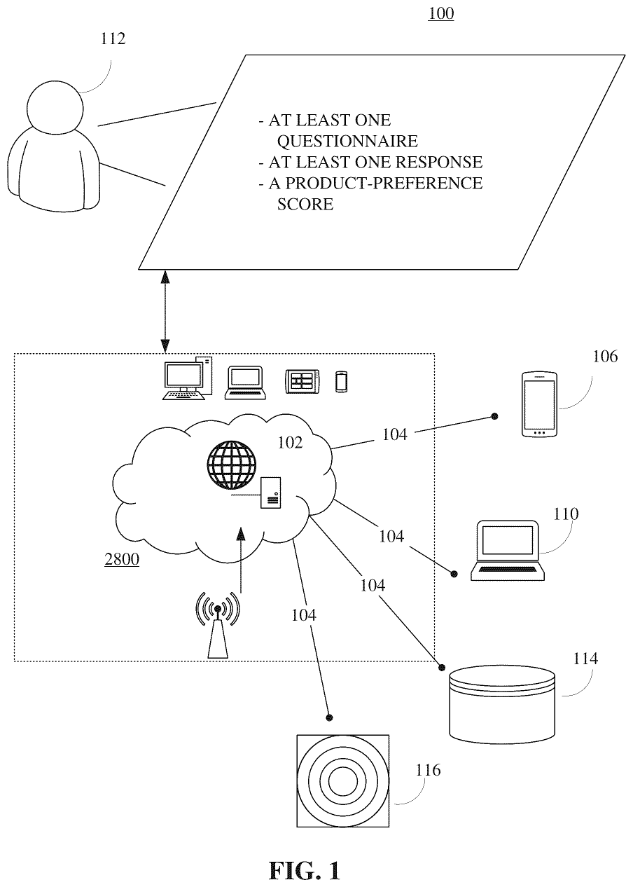

FIG. 1 is an illustration of an online platform 100 consistent with various embodiments of the present disclosure. By way of non-limiting example, the online platform 100 for managing shopping of products by users may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 2800.

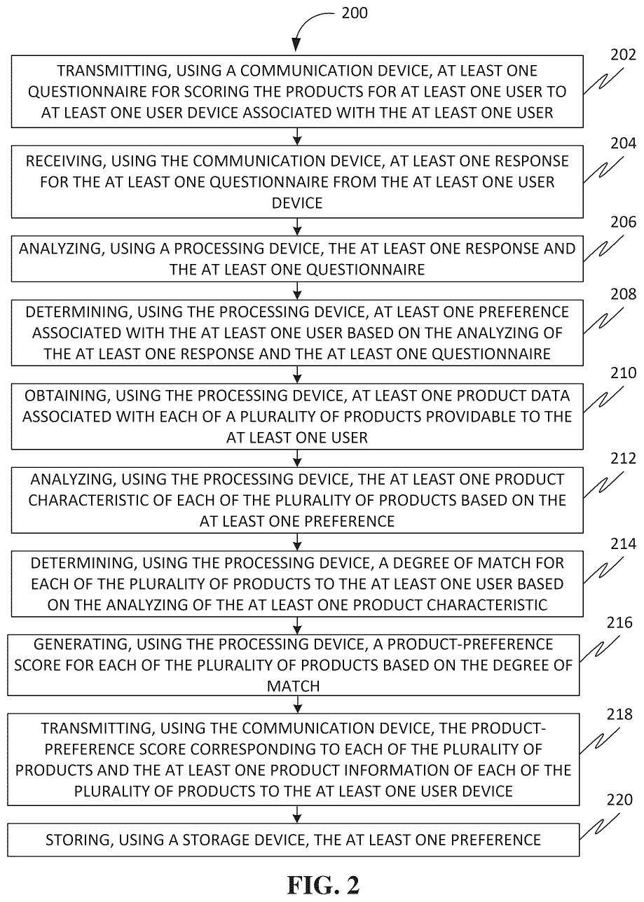

FIG. 2 is a flowchart of a method 200 for managing shopping of products by users, in accordance with some embodiments. Accordingly, at 202 the method 200 may include transmitting, using a communication device, at least one questionnaire for scoring the products for at least one user to at least one user device associated with the at least one user. Further, the at least one questionnaire may include a series of multiple-choice questions corresponding to properties, attributes, types, features, prices, etc., of the products. Further, the at least one user device may include a client device, a computing device, a laptop, a smartphone, a mobile, a tablet, etc. Further, the at least one user may include a buyer, a consumer, a shopper, a business, an entity, an organization, an individual, etc. Further, the products may include items, articles, apparel, objects, vehicles, electronic items, mechanical devices, electrical devices, electromechanical devices, etc., Further, the vehicles may include cars, motorhomes, recreational vehicles (RVs), sport utility vehicles (SUVs), trucks, cars, boats, motorcycles, etc.

Further, at 204 the method 200 may include receiving, using the communication device, at least one response for the at least one questionnaire from the at least one user device. Further, the at least one response may include, a product characteristic, a text, a selection of choice, an answer, etc. Further, the product characteristics may include, for example, a number of wheels in a vehicle, a battery capacity of a smartphone, etc. Further, the at least one user device may include at least one sensor. Further, the at least one sensor may be configured for capturing an information associated with at least one of a gesture, a movement, an expression, a pupil dilation, a gaze, a physiological state, and a biological state of the at least one user. Further, the at least one response may be generated based on the capturing of at least one of the gesture, the movement, the expression, the physiological state, and the biological state of the at least one user. Further, the at least one sensor may include a camera, an infrared image sensor, an eye sensor, a motion sensor, a biometric sensor, a pupil dilation sensor, a skin conductivity sensor, an electroencephalography sensor, etc.

Further, at 206 the method 200 may include analyzing, using a processing device, the at least one response and the at least one questionnaire.

Further, at 208 the method 200 may include determining, using the processing device, at least one preference associated with the at least one user based on the analyzing of the at least one response and the at least one questionnaire. Further, the at least one preference may be associated with prioritizing a characteristic of the product. Further, the at least one preference may correspond to at least one preferred characteristic from a plurality of characteristics of the products. Further, the plurality of characteristics characterizes the products based on design, appearance, functionality, features, etc. of the products.

Further, at 210 the method 200 may include obtaining, using the processing device, at least one product data associated with each of a plurality of products providable to the at least one user. Further, the plurality of products may be available in a marketplace. Further, the marketplace may include an online marketplace, a Searchshop marketplace, etc. Further, the marketplace may be hosted on an online platform. Further, the at least one product data may include at least one product information and at least one product characteristic of each of the plurality of products. Further, the plurality of products may include vehicles, electronic items, mechanical devices, electrical devices, electromechanical devices, etc., for example, cars, motorhomes, etc. Further, the at least one product data may include an identifier, a license plate, name of owner associated with the at least one product data. Further, the at least one product information may include a product identifier, a product model, a product make, a product type, a product price, etc.

Further, at 212 the method 200 may include analyzing, using the processing device, the at least one product characteristic of each of the plurality of products based on the at least one preference.

Further, at 214 the method 200 may include determining, using the processing device, a degree of match for each of the plurality of products to the at least one user based on the analyzing of the at least one product characteristic. Further, the degree of match ranges from a minimum degree of match and a maximum degree of match. Further, the degree of match may include level of similarities. Further, the range of degree of match may include, for example, 0 as the minimum degree of match and 100 as the maximum degree of match.

Further, at 216 the method 200 may include generating, using the processing device, a product-preference score for each of the plurality of products based on the degree of match. Further, the product-preference score may include a percentage ranging from 0 to 100 based on the degree of match. Further, the product-preference score may include a vehiscore.

Further, at 218 the method 200 may include transmitting, using the communication device, the product-preference score corresponding to each of the plurality of products and the at least one product information of each of the plurality of products to the at least one user device.

Further, at 220 the method 200 may include storing, using a storage device, the at least one preference.

In further embodiments, the method 200 may include identifying, using the processing device, at least one product from the plurality of products using the product-preference score for each of the plurality of products based on at least one criterion associated with the product-preference score. Further, the method 200 may include identifying, using the processing device, at least one product provider associated with the at least one product based on the identifying of the at least one product. Further, the method 200 may include generating, using the processing device, at least one alert based on the identifying of the at least one product provider. Further, the at least one alert may include at least one of at least one user information associated with the at least one user and at least one product provider information associated with the at least one product provider. Further, the method 200 may include transmitting, using the communication device, the at least one alert to at least one of the at least one user device and at least one product provider device associated with the at least one product provider.

In further embodiments, the method 200 may include receiving, using the communication device, at least one of a location information of a location of the at least one user and a product usage information associated with a usage of a product. Further, the method 200 may include determining, using the processing device, a type of at least one of the location and the usage based on at least one of the location information and the product usage information. Further, the method 200 may include identifying, using the processing device, at least one question from a plurality of questions based on the type of at least one of the location and the usage. Further, the method 200 may include generating, using the processing device, the at least one questionnaire based on the at least one question. Further, the at least one questionnaire may include the at least one question. Further, the location type may include a historical site, a locality, a jungle, a mountain, a beach, a plain, a forest, etc. Further, the usage type may include street driving, off-roading, hill climbing, etc.

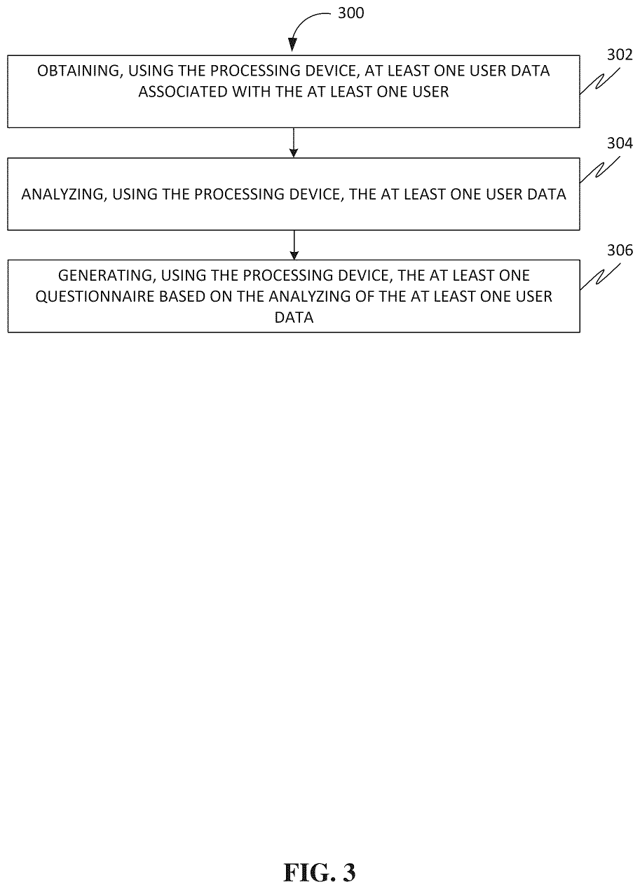

FIG. 3 is a flowchart of a method 300 for managing shopping of products by users, in accordance with some embodiments. Accordingly, at 302 the method 300 may include obtaining, using the processing device, at least one user data associated with the at least one user. Further, the at least one user data may include a usage of the products, a budget for the products, a choice related to the products, a location of the at least one user, etc.

Further, at 304 the method 300 may include analyzing, using the processing device, the at least one user data.

Further, at 306 the method 300 may include generating, using the processing device, the at least one questionnaire based on the analyzing of the at least one user data.

Further, in some embodiments, the obtaining of the at least one user data may include collecting a location data of a vehicle from a Global positioning system (GPS) device of the vehicle. Further, the GPS device may be configured for generating the location data based on a movement of the vehicle along a path connecting to a plurality of locations. Further, the at least one user data may include the location data. Further, the method 300 may include identifying at least one first location proximal to the path based on the analyzing of the location data and a map of a geographical area associated with the plurality of locations. Further, the method 300 may include obtaining, using the processing device, at least one first location information associated with the at least one first location based on the identifying of the at least one first location. Further, the method 300 may include analyzing, using the processing device, the at least one first location information. Further, the method 300 may include determining a type of the at least one first location based on the analyzing. Further, the generating of the at least one questionnaire may be further based on the type of the at least one first location.

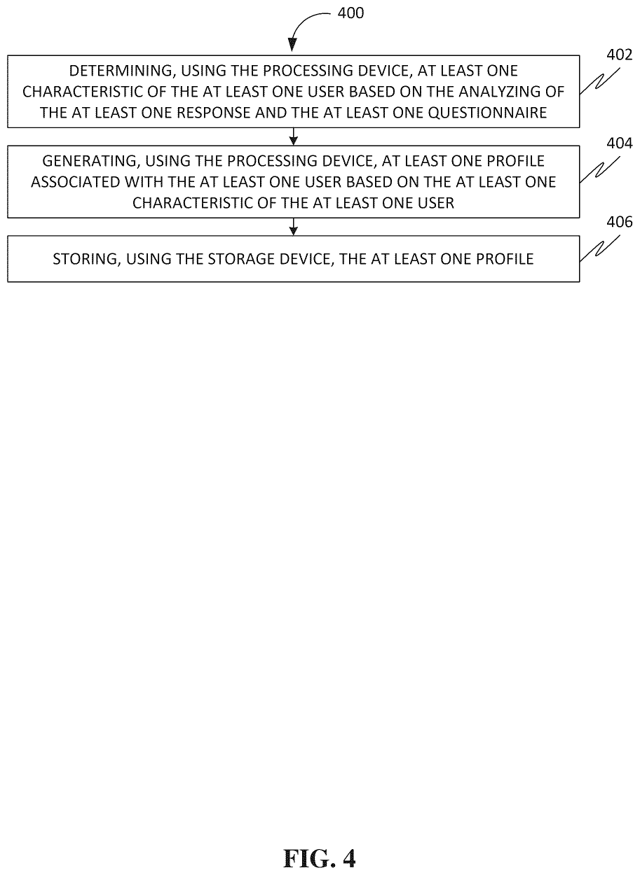

FIG. 4 is a flowchart of a method 400 for managing shopping of products by users, in accordance with some embodiments. Accordingly, at 402 the method 400 may include determining, using the processing device, at least one characteristic of the at least one user based on the analyzing of the at least one response and the at least one questionnaire. Further, the at least one characteristic of the at least one user may include a requirement of the at least one user, a choice of the at least one user, a preference of the at least one user, etc.

Further, at 404 the method 400 may include generating, using the processing device, at least one profile associated with the at least one user based on the at least one characteristic of the at least one user. Further, the at least one profile may include an icon comprising details associated with the at least one user. Further, the details may include a name, a picture, a budget, a requirement, etc.

Further, at 406 the method 400 may include storing, using the storage device, the at least one profile.

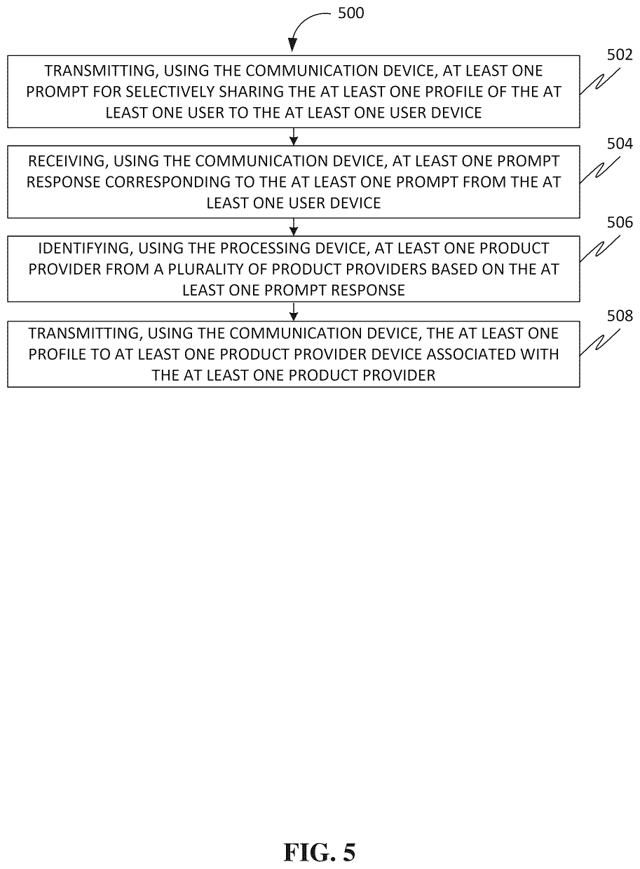

FIG. 5 is a flowchart of a method 500 for managing shopping of products by users, in accordance with some embodiments. Accordingly, at 502 the method 500 may include transmitting, using the communication device, at least one prompt for selectively sharing the at least one profile of the at least one user to the at least one user device. Further, the at least one prompt may include a plurality of sharing options and a plurality of selection options corresponding to at least one selecting criterion. Further, the at least one prompt may include a question, a phrase, a message, etc. Further, the plurality of sharing options may include a plurality of sellers, a plurality of dealerships, etc. Further, the plurality of selection options may include a number of criteria for selecting at least one plurality of sharing options, for example, reviews and ratings, a distance from a location of the at least one user, etc.

Further, at 504 the method 500 may include receiving, using the communication device, at least one prompt response corresponding to the at least one prompt from the at least one user device. Further, the at least one prompt response may include at least one sharing option indication corresponding to at least one of the plurality of sharing options and at least one selection option indication corresponding to at least one of the plurality selection options.

Further, at 506 the method 500 may include identifying, using the processing device, at least one product provider from a plurality of product providers based on the at least one prompt response. Further, the at least one product provider may include at least one seller, at least one dealership, etc.

Further, at 508 the method 500 may include transmitting, using the communication device, the at least one profile to at least one product provider device associated with the at least one product provider. Further, the at least one product provider device may include a client device, a computing device, a smartphone, a tablet, a laptop, a computer, etc.

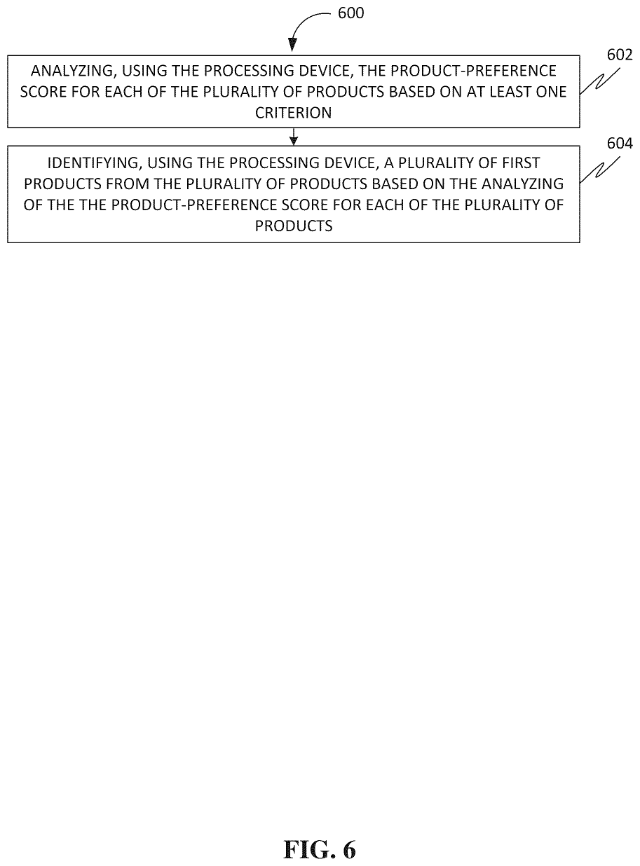

FIG. 6 is a flowchart of a method 600 for managing shopping of products by users, in accordance with some embodiments. Accordingly, at 602 the method 600 may include analyzing, using the processing device, the product-preference score for each of the plurality of products based on at least one criterion. Further, the at least one criterion may include a range of the range of degree of match of the at least one product, for example above 70, above 80, etc.

Further, at 604 the method 600 may include identifying, using the processing device, a plurality of first products from the plurality of products based on the analyzing of the product-preference score for each of the plurality of products. Further, the plurality of first products may be provided by the at least one product provider. Further, the identifying of the at least one product provider from the plurality of product providers may be based on the identifying of the plurality of first products. Further, the plurality of first products may include products coming in the range of the range of degree of match of the at least one product, for example, products above 80 product-preference score, products above 70 product-preference score, etc.

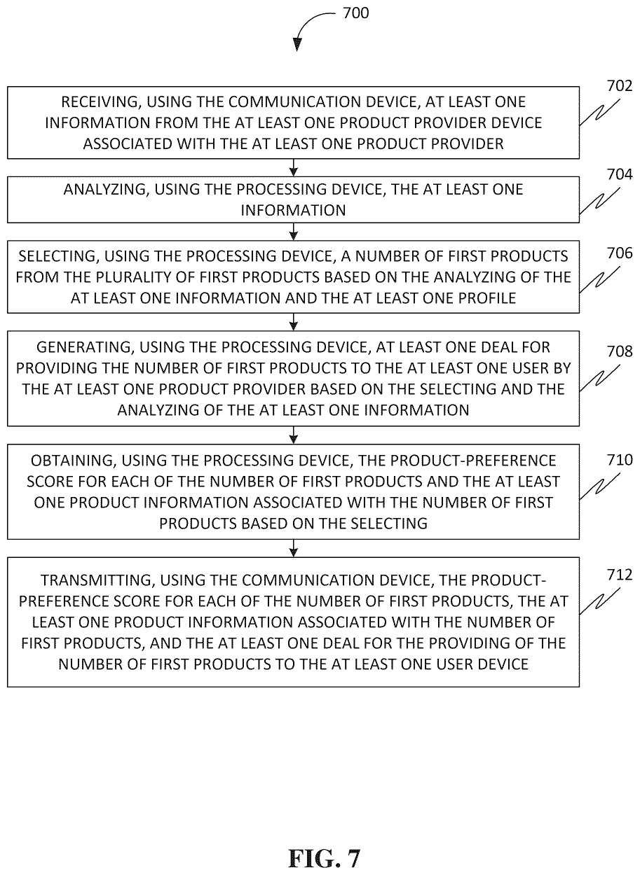

FIG. 7 is a flowchart of a method 700 for managing shopping of products by users, in accordance with some embodiments. Accordingly, at 702 the method 700 may include receiving, using the communication device, at least one information from the at least one product provider device associated with the at least one product provider. Further, the at least one information may include an ownership of a product, model of a product, price of a product, a discount offered on a product, a constrained discount on a product, etc.

Further, at 704 the method 700 may include analyzing, using the processing device, the at least one information.

Further, at 706 the method 700 may include selecting, using the processing device, a number of first products from the plurality of first products based on the analyzing of the at least one information and the at least one profile. Further, the number of first products may include products with a particular characteristic, for example, a product manufactured in a particular year, a product of a particular price range, etc.

Further, at 708 the method 700 may include generating, using the processing device, at least one deal for providing the number of first products to the at least one user by the at least one product provider based on the selecting and the analyzing of the at least one information. Further, the at least one deal may include a list comprising the number of first products, an offer on at least one of the number of first products, etc.

Further, at 710 the method 700 may include obtaining, using the processing device, the product-preference score for each of the number of first products and the at least one product information associated with the number of first products based on the selecting.

Further, at 712 the method 700 may include transmitting, using the communication device, the product-preference score for each of the number of first products, the at least one product information associated with the number of first products, and the at least one deal for the providing of the number of first products to the at least one user device.

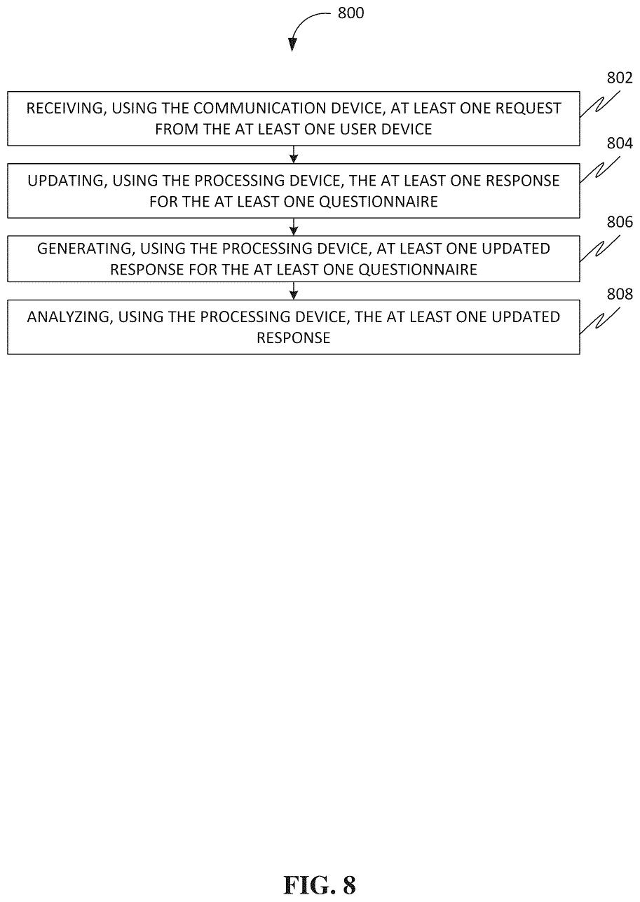

FIG. 8 is a flowchart of a method 800 for managing shopping of products by users, in accordance with some embodiments. Accordingly, at 802 the method 800 may include receiving, using the communication device, at least one request from the at least one user device. Further, the at least one request may include a text, a plurality of first answers, etc.

Further, at 804 the method 800 may include updating, using the processing device, the at least one response for the at least one questionnaire.

Further, at 806 the method 800 may include generating, using the processing device, at least one updated response for the at least one questionnaire. Further, the at least one updated response may include an updated plurality of first answers.

Further, at 808 the method 800 may include analyzing, using the processing device, the at least one updated response. Further, the generating of the at least one preference may be further based on the analyzing of the at least one updated response.

Further, in some embodiments, the at least one questionnaire may include a plurality of questions for the scoring of the products. Further, the plurality of questions may include, for example, year of manufacturing of the product, price of the product, location of the seller, etc. Further, the at least one response may include at least one answer corresponding to at least one of the plurality of questions. Further, the analyzing of the at least one response and the at least one questionnaire may include analyzing the at least one answer corresponding to at least one of the plurality of questions and the plurality of questions using at least one machine learning model. Further, the at least one machine learning model may include a convolutional neural network, a recurrent neural network, etc. Further, the determining of the at least one preference may be based on the analyzing of the at least one answer corresponding to at least one of the plurality of questions and the plurality of questions using the at least one machine learning model. Further, in an embodiment, the at least one machine learning model may include a random forest model. Further, the plurality of answers may be associated with a pattern based on the plurality of questions. Further, the random forest model may be trained using a training data. Further, the training data may include preferences determined from historical answers to the plurality of questions, features describing characteristics (such as semantic characteristics, syntactic characteristics, contextual characteristics, etc.) of answers and the plurality of questions. Further, the random forest model may include a plurality of tree models. Further, each of the plurality of tree models generates a preliminary preference based on the pattern of the plurality of answers corresponding to the plurality of questions. Further, the at least one preference may be determined based on the preliminary preference generated by each of the plurality of tree models.

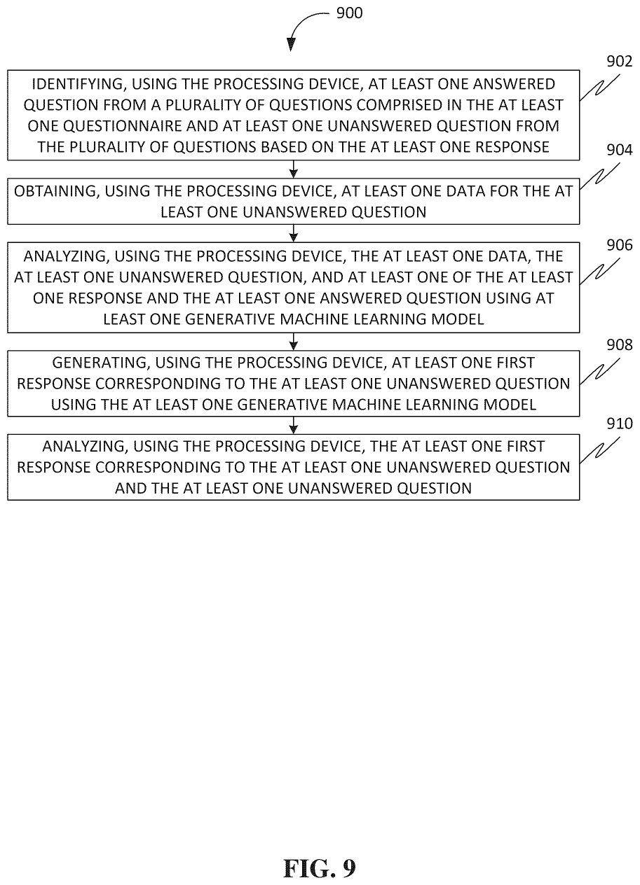

FIG. 9 is a flowchart of a method 900 for managing shopping of products by users, in accordance with some embodiments. Accordingly, at 902 the method 900 may include identifying, using the processing device, at least one answered question from a plurality of questions comprised in the at least one questionnaire and at least one unanswered question from the plurality of questions based on the at least one response. Further, the plurality of questions may include the at least one answered question and the at least one unanswered question. Further, the at least one response corresponds to the at least one answered question.

Further, at 904 the method 900 may include obtaining, using the processing device, at least one data for the at least one unanswered question. Further, the at least one data characterizes the at least one user and the at least one user device. Further, the obtaining of the at least one data may include obtaining the at least one data from at least one sensor comprised in the at least one user device. Further, the at least one sensor may be configured for generating at least one sensor data based on detecting at least one a physical state of the at least one user device, a physiological state of the at least one user, and a biometric of the at least one user.

Further, at 906 the method 900 may include analyzing, using the processing device, the at least one data, the at least one unanswered question, and at least one of the at least one response and the at least one answered question using at least one generative machine learning model. Further, the at least one generative machine learning model may be a trained generative machine learning model and include a variational autoencoder comprising an encoder and a decoder.

Further, at 908 the method 900 may include generating, using the processing device, at least one first response corresponding to the at least one unanswered question using the at least one generative machine learning model.

Further, at 910 the method 900 may include analyzing, using the processing device, the at least one first response corresponding to the at least one unanswered question and the at least one unanswered question. Further, the analyzing of the at least one response and the at least one questionnaire may include analyzing the at least one response and the at least one answered question. Further, the determining of the at least one preference may be further based on the analyzing of the at least one response and the at least one answered question and the analyzing of the at least one first response and the at least one unanswered question.

Further, in some embodiments, the at least one user device may include at least one sensor. Further, the at least one sensor may include a camera, a motion sensor, a physiological sensor, a physical sensor, a biometric sensor, an ultrasonic sensor, an infrared sensor, etc. Further, the at least one sensor may be configured for generating at least one sensor data based on detecting at least one of a physical state, a physiological state, and a biometric of the at least one user. Further, the at least one response may include the at least one sensor data.

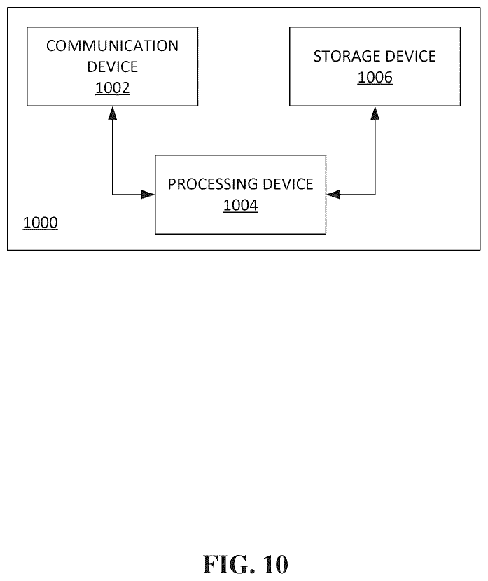

FIG. 10 is a block diagram of a system 1000 for managing shopping of products by users, in accordance with some embodiments. Accordingly, the system 1000 may include a communication device 1002, a processing device 1004, and a storage device 1006.

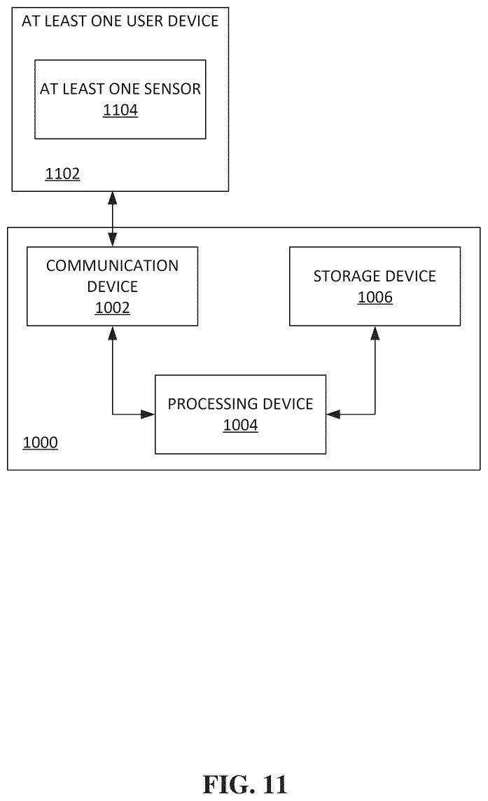

Further, the communication device 1002 may be configured for transmitting at least one questionnaire for scoring the products for at least one user to at least one user device 1102, as shown in FIG. 11, associated with the at least one user. Further, the communication device 1002 may be configured for receiving at least one response for the at least one questionnaire from the at least one user device 1102. Further, the communication device 1002 may be configured for transmitting a product-preference score corresponding to each of a plurality of products and at least one product information of each of the plurality of products to the at least one user device 1102. Further, the at least one questionnaire may include a series of multiple choice questions corresponding to properties of the products associated with the at least one user. Further, the at least one user device 1102 may include a laptop, a smartphone, a mobile, a tablet, etc. Further, the at least one user may include a buyer, a consumer, a shopper, a business, an entity, an organization, an individual, etc. Further, the products may include vehicles, electronic items, mechanical devices, electrical devices, electromechanical devices, etc., for example, cars, motorhomes, etc. Further, the at least one response may include, a product characteristic, a text, a selection of choice, an answer, etc. Further, the product characteristic may include, for example, number of wheels in a vehicle, battery capacity of a mobile, etc.

Further, the processing device, 1004 may be communicatively coupled with the communication device 1002. Further, the processing device 1004 may be configured for analyzing the at least one response and the at least one questionnaire. Further, the processing device 1004 may be configured for determining at least one preference associated with the at least one user based on the analyzing of the at least one response and the at least one questionnaire. Further, the at least one preference may be associated with prioritizing a characteristic of the product. Further, the processing device 1004 may be configured for obtaining at least one product data associated with each of the plurality of products providable to the at least one user. Further, the plurality of products may include vehicles, electronic items, mechanical devices, electrical devices, electromechanical devices, etc., for example, cars, motorhomes, etc. Further, the at least one product data may include an identifier, a license plate, name of an owner associated with the at least one product data. Further, the at least one product data may include the at least one product information and at least one product characteristic of each of the plurality of products. Further, the processing device 1004 may be configured for analyzing the at least one product characteristic of each of the plurality of products based on the at least one preference. Further, the processing device 1004 may be configured for determining a degree of match for each of the plurality of products to the at least one user based on the analyzing of the at least one product characteristic. Further, the degree of match ranges from a minimum degree of match and a maximum degree of match. Further, the degree of match may include level of similarities. Further, the range of degree of match may include, for example 0 as the minimum degree of match and 100 as the maximum degree of match. Further, the processing device 1004 may be configured for generating the product-preference score for each of the plurality of products based on the degree of match. Further, the product-preference score may include a number ranging from 0 to 100 based on the degree of match.

Further, the storage device 1006 may be communicatively coupled with the processing device 1004. Further, the storage device 1006 may be configured for storing the at least one preference.

Further, in some embodiments, the processing device 1004 may be further configured for obtaining at least one user data associated with the at least one user. Further, the processing device 1004 may be further configured for analyzing the at least one user data. Further, the processing device 1004 may be further configured for generating the at least one questionnaire based on the analyzing of the at least one user data. Further, the at least one user data may include a budget, a choice, a location of the at least one user, etc.

Further, in some embodiments, the processing device 1004 may be further configured for determining at least one characteristic of the at least one user based on the analyzing of the at least one response and the at least one questionnaire. Further, in some embodiments, the processing device 1004 may be further configured for generating least one profile associated with the at least one user based on the at least one characteristic of the at least one user. Further, the storage device 1006 may be further configured for storing at least one profile. Further, the at least one characteristics of the at least one user may include a requirement of the at least one user, a choice of the at least one user, etc.

Further, in an embodiment, the communication device 1002 may be further configured for transmitting at least one prompt for selectively sharing the at least one profile of the at least one user to the at least one user device 1102. Further, the at least one prompt may include a plurality of sharing options and a plurality of selection options corresponding to at least one selecting criterion. Further, the at least one prompt may include a question, a phrase, message, etc. Further, the plurality of sharing options may include a plurality of sellers, a plurality of dealerships, etc. Further, the plurality of selection option may include a number of criteria for selecting at least one plurality of sharing options, for example, reviews and ratings on internet, distance from location of the at least one user. Further, the communication device 1002 may be further configured for receiving at least one prompt response corresponding to the at least one prompt from the at least one user device 1102. Further, the at least one prompt response may include at least one sharing option indication corresponding to at least one of the plurality of sharing options and at least one selection option indication corresponding to at least one of the plurality selection options. Further, the communication device 1002 may be further configured for transmitting the at least one profile to at least one product provider device associated with at least one product provider. Further, the at least on product provider may include at least one seller, at least one dealership, etc. Further, the at least one product provider device may include a smartphone, a tablet, a laptop, a pc, etc. Further, the processing device 1004 may be further configured for identifying the at least one product provider from a plurality of product providers based on the at least one prompt response.

Further, in an embodiment, the processing device 1004 may be further configured for analyzing the product-preference score for each of the plurality of products based on at least one criterion. Further, the processing device 1004 may be further configured for identifying a plurality of first products from the plurality of products based on the analyzing of the product-preference score for each of the plurality of products. Further, the at least one criterion may include a range of the range of degree of match of the at least one product, for example above 70, above 80, etc. Further, the plurality of first products may be provided by the at least one product provider. Further, the identifying of the at least one product provider from the plurality of product providers may be further based on the identifying of the plurality of first products.

Further, in an embodiment, the communication device 1002 may be further configured for receiving at least one information from the at least one product provider device associated with the at least one product provider. Further, the communication device 1002 may be further configured for transmitting the product-preference score for each of a number of first products, the at least one product information associated with the number of first products, and at least one deal for the providing of the number of first products to the at least one user device 1102. Further, the processing device 1004 may be configured for analyzing the at least one information. Further, the processing device 1004 may be configured for selecting the number of first products from the plurality of first products based on the analyzing of the at least one information and the at least one profile. Further, the processing device 1004 may be configured for generating the at least one deal for providing the number of first products to the at least one user by the at least one product provider based on the selecting and the analyzing of the at least one information. Further, the processing device 1004 may be configured for obtaining the product-preference score for each of the number of first products and the at least one product information associated with the number of first products based on the selecting. Further, the plurality of first products may include products coming in the range of the range of degree of match of the at least one product, for example, products above 80 product-preference score, products above 70 product-preference score, etc.

Further, in some embodiments, the communication device 1002 may be further configured for receiving at least one request from the at least one user device 1102. Further, the processing device 1004 may be further configured for updating the at least one response for the at least one questionnaire. Further, the at least one request may include a text, a plurality of first answers, etc. Further, the processing device 1004 may be further configured for generating at least one updated response for the at least one questionnaire. Further, the at least one updated response may include an updated plurality of first answers. Further, the processing device 1004 may be further configured for analyzing the at least one updated response. Further, the generating of the at least one preference may be further based on the analyzing of the at least one updated response.

Further, in some embodiments, the at least one questionnaire may include a plurality of questions for the scoring of the products. Further, the at least one response may include at least one answer corresponding to at least one of the plurality of questions. Further, the plurality of questions may include, for example, year of manufacturing of the product, price of the product, location of the seller, etc. Further, the analyzing of the at least one response and the at least one questionnaire may include analyzing the at least one answer corresponding to at least one of the plurality of questions and the plurality of questions using at least one machine learning model. Further, the at least one machine learning model may include a convolutional neural network, a recurrent neural network, etc. Further, the determining of the at least one preference may be further based on the analyzing of the at least one answer corresponding to at least one of the plurality of questions and the plurality of questions using the at least one machine learning model.

Further, in some embodiments, the processing device 1004 may be further configured for identifying at least one answered question from a plurality of questions comprised in the at least one questionnaire and at least one unanswered question from the plurality of questions based on the at least one response. Further, the plurality of questions may include the at least one answered question and the at least one unanswered question. Further, the at least one response corresponds to the at least one answered question. Further, the processing device 1004 may be further configured for obtaining at least one data for the at least one unanswered question. Further, the processing device 1004 may be further configured for analyzing the at least one data, the at least one unanswered question, and at least one of the at least one response and the at least one answered question using at least one generative machine learning model. Further, the at least one generative machine learning model may include, for example, DALL E2. Further, the processing device 1004 may be further configured for generating at least one first response corresponding to the at least one unanswered question using the at least one generative machine learning model. Further, the processing device 1004 may be further configured for analyzing the at least one first response corresponding to the at least one unanswered question and the at least one unanswered question. Further, the analyzing of the at least one response and the at least one questionnaire may include analyzing the at least one response and the at least one answered question. Further, the determining of the at least one preference may be further based on the analyzing of the at least one response and the at least one answered question and the analyzing of the at least one first response and the at least one unanswered question.

Further, in some embodiments, the at least one user device 1102 may include at least one sensor 1104, as shown in FIG. 11. Further, the at least one sensor 1104 may be configured for generating at least one sensor data based on detecting at least one of a physical state, a physiological state, and a biometric of at least one user. Further, the at least one sensor may include an ultrasonic sensor, an infrared sensor, etc. Further, the at least one response may include the at least one sensor data. Further, the at least one sensor data may include a height of the at least one user.

FIG. 11 is a block diagram of the system 1000 for managing shopping of products by the users, in accordance with some embodiments.

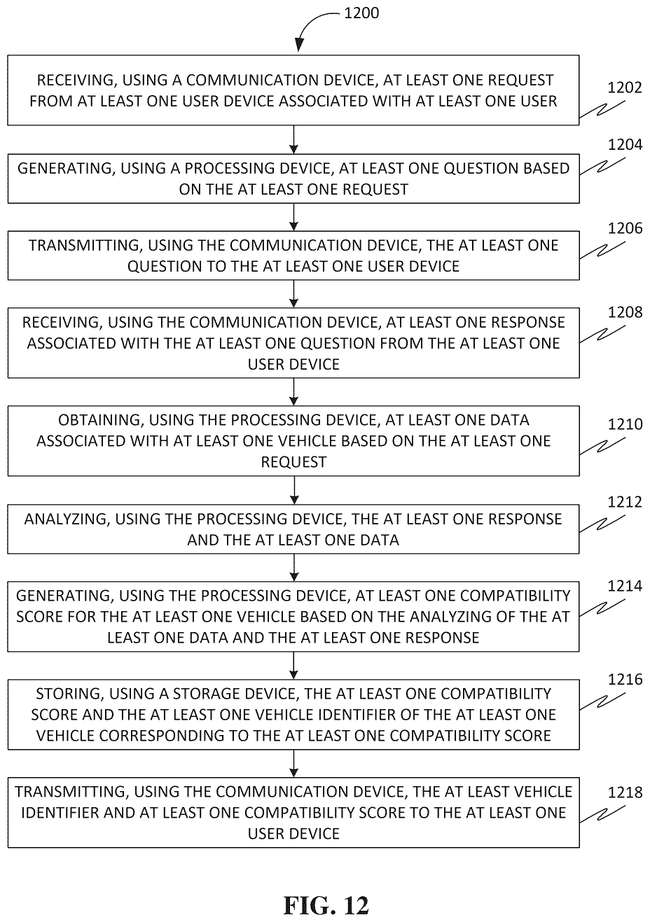

FIG. 12 is a flowchart of a method 1200 for facilitating managing vehicles for users, in accordance with some embodiments. Accordingly, at 1202 the method 1200 may include receiving, using a communication device, at least one request from at least one user device associated with at least one user. Further, the at least one request may include a request to buy a vehicle, a request to rent a vehicle, etc. Further, the at least one request may include a type of a vehicle. Further, the type of the vehicle may include a recreational vehicle (RV), a sport utility vehicle (SUV), a truck, a car, a boat, a motorcycle, etc. Further, the at least one user device may include a laptop, a smartphone, a tablet, a smartwatch, etc. Further, the at least one user may include a buyer, a consumer, a client, an individual, an organization, an institution, etc.

Further, at 1204 the method 1200 may include generating, using a processing device, at least one question based on the at least one request. Further, the at least one question may a question related to a type of engine of the vehicle, a question related to a drive terrain of the vehicle, a question related to a usage of the vehicle, a question related to a seating of the vehicle, a question related to an interior space of the vehicle, etc.

Further, at 1206 the method 1200 may include transmitting, using the communication device, the at least one question to the at least one user device.

Further, at 1208 the method 1200 may include receiving, using the communication device, at least one response associated with the at least one question from the at least one user device. Further, the at least one response may include an answer associated with the at least one question.

Further, at 1210 the method 1200 may include obtaining, using the processing device, at least one data associated with at least one vehicle based on the at least one request. Further, the at least one data may include at least one vehicle identifier and at least one vehicle data. Further, the at least one vehicle identifier and the at least one vehicle data may be associated with the at least one vehicle. Further, the at least one vehicle identifier may include a vehicle identification number, a name of a vehicle, a model of a vehicle, etc., associated with the at least one vehicle. Further, the at least one vehicle data may include a type of an engine of the at least one vehicle, a capacity of the at least one vehicle, a drive terrain of the at least one vehicle, etc.

Further, at 1212 the method 1200 may include analyzing, using the processing device, the at least one response and the at least one data. Further, the analyzing of the at least one response and the at least one data may include matching the at least one response with the at least one data.

Further, at 1214 the method 1200 may include generating, using the processing device, at least one compatibility score for the at least one vehicle based on the analyzing of the at least one data and the at least one response. Further, the at least one compatibility score may be a match score between a requirement of the at least one user and a feature of the at least one vehicle.

Further, at 1216 the method 1200 may include storing, using a storage device, the at least one compatibility score and the at least one vehicle identifier of the at least one vehicle corresponding to the at least one compatibility score.

Further, at 1218 the method 1200 may include transmitting, using the communication device, the at least one vehicle identifier and the at least one compatibility score to the at least one user device.

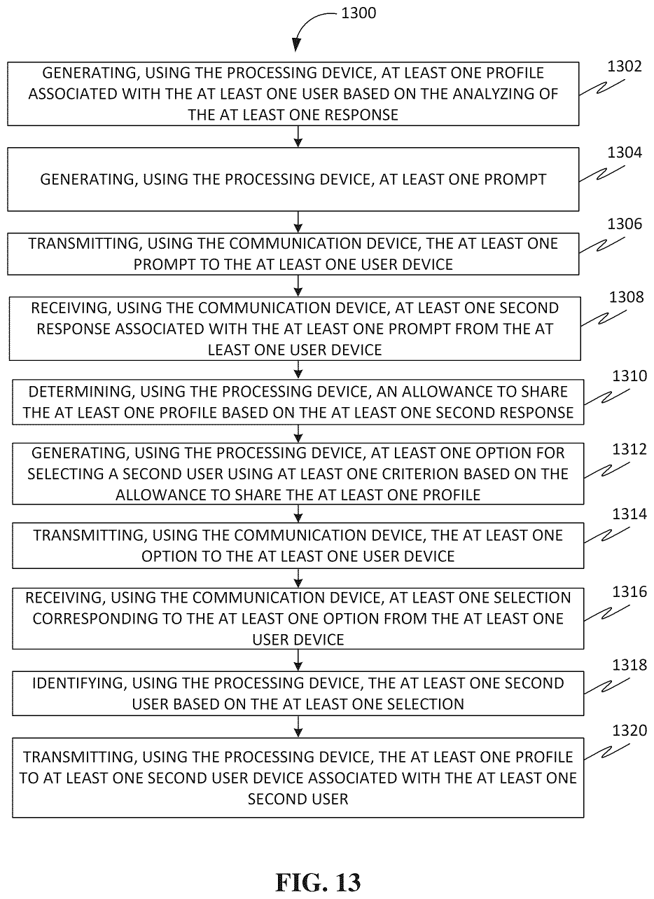

FIG. 13 is a flowchart of a method 1300 for facilitating personalized shopping of vehicles, in accordance with some embodiments. Accordingly, at 1302 the method 1300 may include generating, using the processing device, at least one profile associated with the at least one user based on the analyzing of the at least one response.

Further, at 1304 the method 1300 may include generating, using the processing device, at least one prompt based on the generating of the at least one profile. Further, the at least one prompt may include at least one second question. Further, the generating of the at least one prompt may be based on the generating of the at least one profile.

Further, at 1306 the method 1300 may include transmitting, using the communication device, the at least one prompt to the at least one user device. Further, the at least one prompt may include a text, an image, an audio, etc.

Further, at 1308 the method 1300 may include receiving, using the communication device, at least one second response associated with the at least one prompt from the at least one user device. Further, the at least one second response may include a positive response and a negative response. Further, the positive response may include a permission to share the at least one profile. Further, the negative response may include a prohibition to share the at least one profile.

Further, at 1310 the method 1300 may include determining, using the processing device, an allowance to share the at least one profile based on the at least one second response.

Further, at 1312 the method 1300 may include generating, using the processing device, at least one option for selecting a second user using at least one criterion based on the allowance to share the at least one profile. Further, the at least one option may be at least one indication of the second user. Further, the second user may be a dealer, a seller, etc., of one or more vehicles. Further, the at least one criterion may include a proximity of the second user to the at least one user, a rating of the second user, etc.

Further, at 1314 the method 1300 may include transmitting, using the communication device, the at least one option to the at least one user device.

Further, at 1316 the method 1300 may include receiving, using the communication device, at least one selection corresponding to the at least one option from the at least one user device.

Further, 1318 the method 1300 may include identifying, using the processing device, at least one second user based on the at least one selection.

Further, 1320 the method 1300 may include transmitting, using the processing device, the at least one profile to at least one second user device associated with the at least one second user. Further, the at least one second user device may include a smartphone, a tablet, a laptop, a smartwatch, etc.

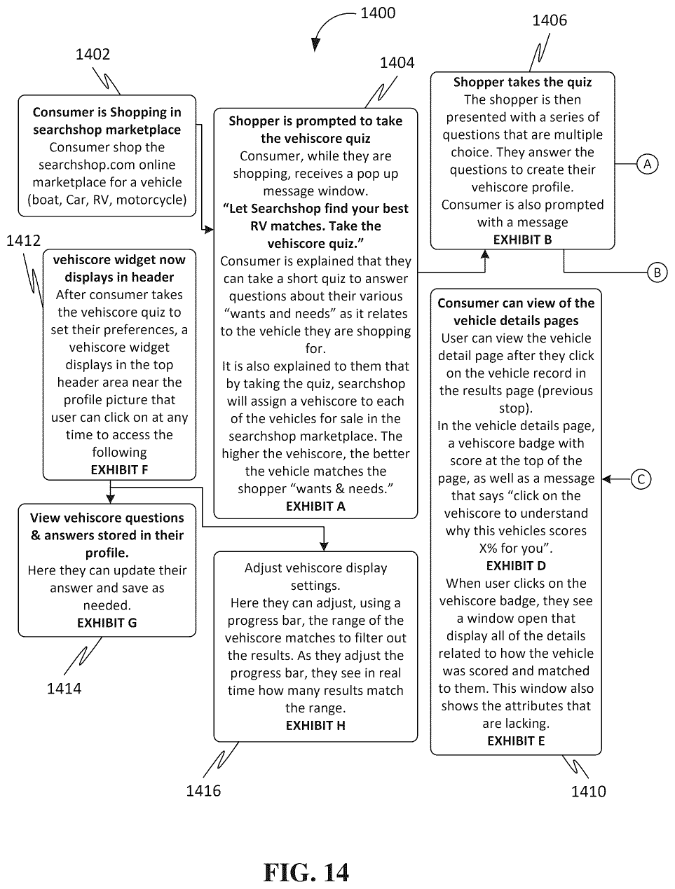

FIG. 14 is a flow diagram of a method 1400 for facilitating personalized shopping of vehicles, in accordance with some embodiments. Accordingly, at 1402, the method 1400 may include consumer shopping in searchshop marketplace. Further, the consumer shop the searchshop.com online marketplace for a vehicle (boat, Car, RV, motorcycle). Further, the consumer may include a user, a shopper, etc.

Further, at 1404, the method 1400 may include prompting the shopper to take the Vehiscore quiz. Consumer, while they are shopping, receives a pop up message window “Let Searchshop find your best RV matches. Take the Vehiscore quiz.” Further, the consumer may be explained that they may take a short quiz to answer questions about various “wants and needs” related to the vehicle the consumer may be shopping for. Further, explained to the consumer that by taking the quiz, searchshop will assign a Vehiscore to each of the vehicles for sale in the searchshop marketplace. The higher the Vehiscore, the better the vehicle matches the shopper “wants & needs.”

Further, at 1406, the method 1400 may include shopper taking the quiz. Further, the shopper may be presented with a series of questions comprising multiple choice. Further, the shopper may answer the questions to create Vehiscore profile for the shopper. Further, the consumer is also prompted with a message.

Further, at 1408, the method 1400 may include returning the consumer to marketplace listings with Vehiscores established. Further, the shopper then returns to the shopping listing on the website marketplace and there they will see a Vehiscore badge on each of the vehicles with a match score.

Further, at 1410, the method 1400 may include presenting the consumer with a vehicle details pages. Further, user can view the vehicle detail page after they click on the vehicle record in the results page (previous stop). Further, the vehicle details page presents a Vehiscore badge with score at the top of the page, as well as a message that says “click on the Vehiscore to understand why this vehicles scores X % for you”. Further, the user clicks on the Vehiscore badge, to see a window open that display all of the details related to how the vehicle was scored and matched to consumer. This window also shows the attributes that are lacking.

Further, at 1412, the method 1400 may include a step displaying Vehiscore widget now in header. After consumer takes the Vehiscore quiz to set the preferences, a Vehiscore widget displays in the top header area near the profile picture that user can click on at any time to access the following.

Further, at 1414, the method 1400 may include viewing Vehiscore questions & answers stored in the profile. Here the consumer can update their answer and save as needed.

Further, at 1416, the method 1400 may include providing adjusting Vehiscore display settings. Here the consumer can adjust, using a progress bar, the range of the Vehiscore matches to filter out the results. As they adjust the progress bar, they see in real-time how many results match the range.

Further, at 1418, the method 1400 may include prompting consumer with a message “Would you like to share this information with RV Dealers on Searchshop so they can reach out to you if they have an RV that has a good Vehiscore match for you?” Further, shoppers can opt to share their information with dealers in searchshop.

Further, at 1420, the method 1400 may include shopper choosing “yes” to share their information, they choose which dealers they want to share within two criteria. Further, the consumer is prompted to make a selection within two criteria types (Dealer Radius & Minimum Review Score). Further, the radius may include a radius from their location to include dealer to share with. Further, the Minimum review score may include rating of dealers to share with.

Further, at 1422, the method 1400 may include pushing Vehiscore profile to the dealer dashboard as an alert. When dealers log into their Dealers Dashboard, they have an alert called “Vehiscore Alerts”. In this alert, a count displays that represent how many shoppers have a vehiscore profile that has an RV match (or multiple matches) from that dealer's inventory. For example, if a customer “John Smith” creates a new Vehiscore profile, when shopping in the searchshop marketplace, and “ABC RV Dealer” has 5RVS that is a 50% or more match, (50% will be the cutoff), then in the Vehiscore Alert box, one would be added to the count that represents “John Smith”. If there are 3 customers that have created Vehiscore profile that have matches that are 50% or more for the “ABC RV Dealers” inventory, then three would display in that alert box.

Further, at 1424, the method 1400 may include a step where the dealer can view customer records and vehicle matches from their inventory. Further, when the dealer clicks on the alert, they see the list of the shoppers in a grid format that represents all the customers from the alert box that have matched one or multiple inventory items from the Dealer. The dealer can see the basic customer contact information in that record as well as click on a button in the customer grid row for “See X matches” (where X represents how many vehicle in the inventory are a match). The dealer opens that list of inventory matches to understand which vehicles from their inventory match the shopper's Vehiscore profile. The dealer can also click on a button in the grid row for “view profile” that opens a page showing the customer quiz questions and answers so they can more thoroughly understand the shopper's needs based on the specific answer in their Vehiscore profile.

Further, at 1426, the method 1400 may include a step where the dealer can email the customer a personalized Vehiscore showroom to view their matches. At the top of that page that displays the inventory list, there is a button called “Create Vehiscore Showroom”. When the dealer clicks on that button an email is automatically started with an automatically generated link to the Vehiscore showroom specific to that customer, that contains their vehicle matches (and scores) and the dealer can type a message and send it to the shopper introducing their selves and inviting them to click on the link to visit the showroom. The showroom also contains any offer and relevant dealer information from the dealer profile (like military discounts offered, address, contact phone number, sales representative contact info, etc.) Additionally, when the dealer clicks the button to create the showroom, they will also first see a window that allows them to select which of the vehicles they want to be included in the showroom (for example they may only want to include 90% plus matches).

Further, in some embodiments, the method may include a consumer shopping in searchshop marketplace. Further, the method may include of prompting the consumer to take a vehiscore quiz. Further, the method may include the consumer taking the quiz. Further, the quiz may include presenting a series of questions to the consumer and collecting answers associated with the series of questions for creating a vehiscore profile based on the answers. Further, the method may include returning to marketplace listing with the vehiscore established. Further, the marketplace listing will have a vehiscore badge on each of the vehicles with a match score. Further, the method may include the consumer viewing any of the vehicle detail pages by clicking on the vehicle's listing which displays a window with all the details of how the vehicle is scored and matched to them. Further, the method may include displaying a vehiscore widget in the header. Further, the method may include viewing and updating the vehiscore quiz's questions and answers stored in their profile. Further, the method may include adjusting vehiscore settings to change a range of vehiscore matches they can see. Further, the method may include prompting the consumers with a message to share their profile with dealers in searchshop. Further, the method may include prompting the consumers to make a selection based on criteria such as radius from their location to include dealers, and minimum vehiscore rating of the dealer if the consumer agrees to share their profile with dealers. Further, the method may include pushing the vehiscore profile to the dealer dashboard as an alert. Further, the method may include dealers viewing consumer and vehicle matches from their inventory. Further, the method may include displaying the quiz questions and answers to the dealer. Further, the method may include creating a personalized vehiscore showroom for the consumer. Further, the creating may include selecting vehicles according to their vehiscore. Further, the method may include mailing a link of the personalized showroom to the consumer.

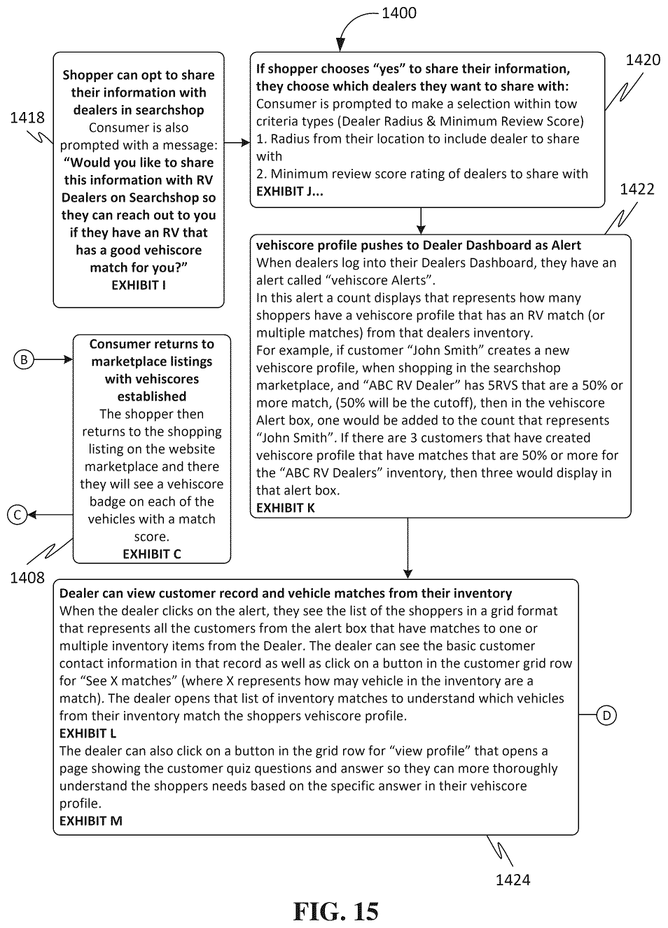

FIG. 15 is a continuation flow diagram of the method 1400 for facilitating the personalized shopping of the vehicles, in accordance with some embodiments.

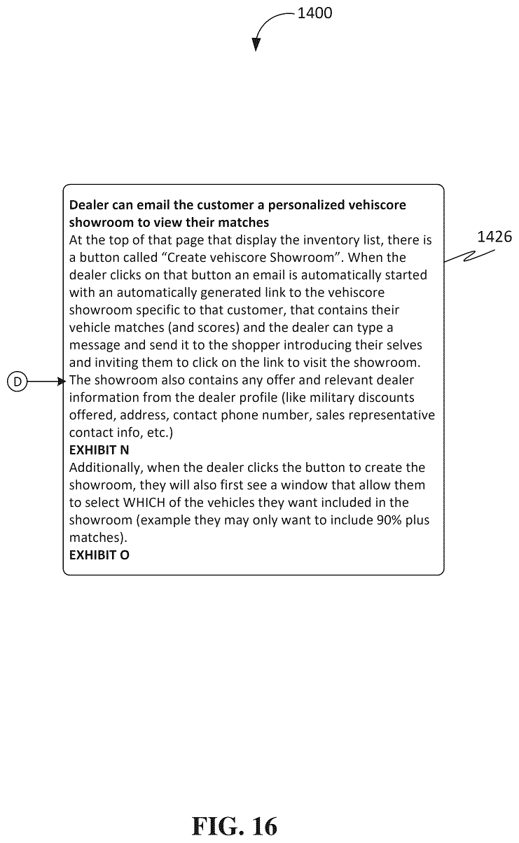

FIG. 16 is a continuation flow diagram of the method 1400 for facilitating the personalized shopping of the vehicles, in accordance with some embodiments.

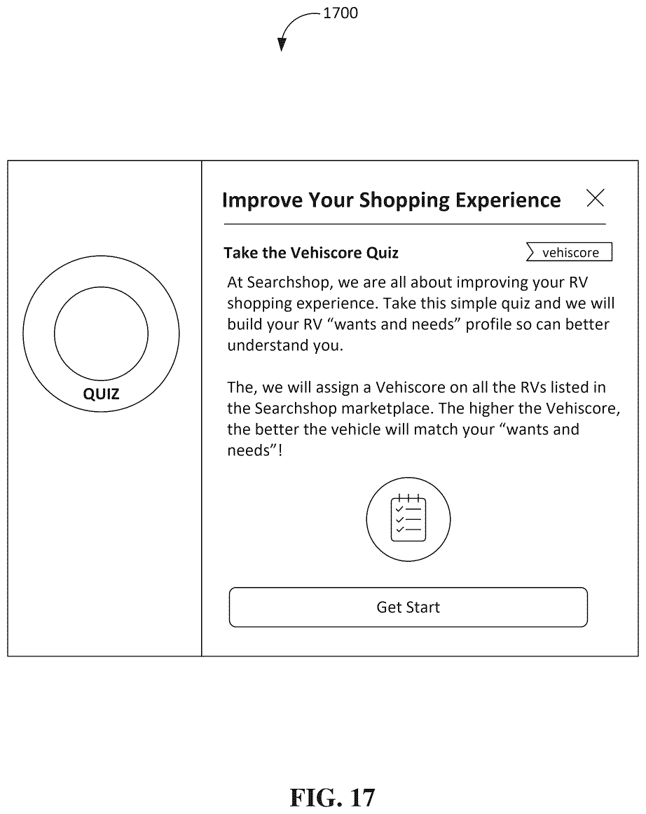

FIG. 17 is a screenshot of a user interface 1700 of an application for facilitating personalized shopping of vehicles, in accordance with some embodiments. Further, the application may be vehiscore. Further, the user interface displays a prompt to a consumer to take a vehiscore quiz. Further, the consumer may be a shopper.

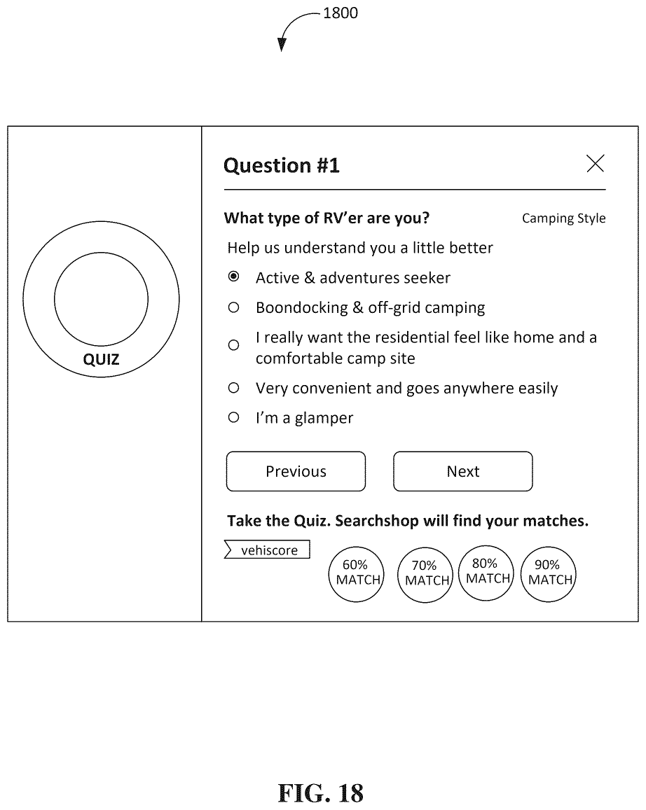

FIG. 18 is a screenshot of a user interface 1800 of the application for facilitating the personalizing shopping of the vehicles, in accordance with some embodiments. Further, the user interface displays a series of questions associated with the vehiscore quiz.

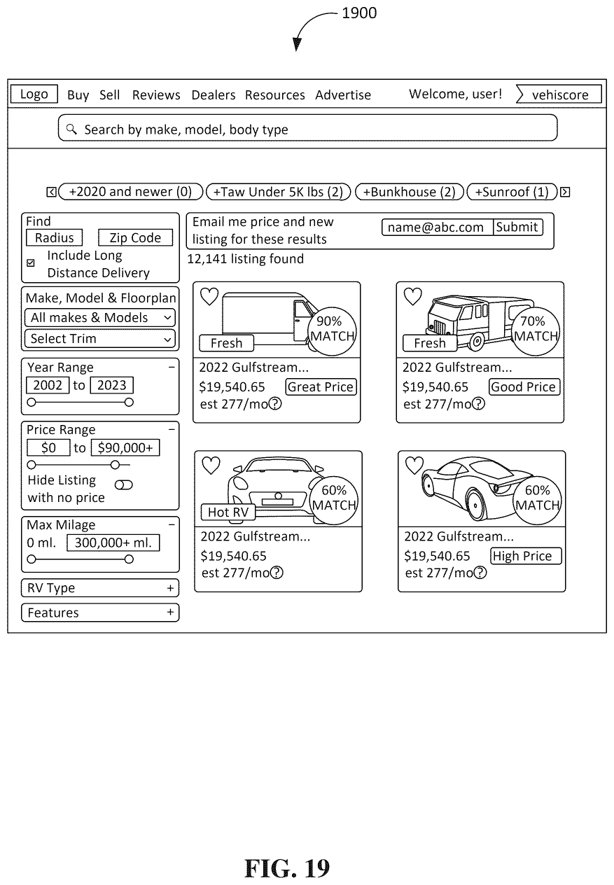

FIG. 19 is a screenshot of a user interface 1900 of the application for facilitating the personalizing shopping of the vehicles, in accordance with some embodiments. Further, the user interface displays shopping listings with a vehiscore badge on each vehicle listed in the shopping listings with a match score.

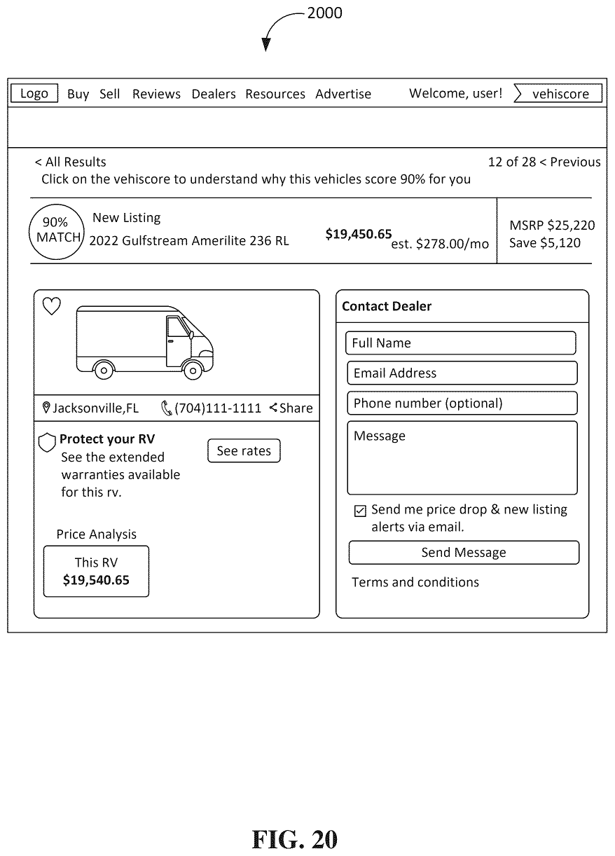

FIG. 20 is a screenshot of a user interface 2000 of the application for facilitating the personalizing shopping of the vehicles, in accordance with some embodiments. Further, the user interface displays vehicle details.

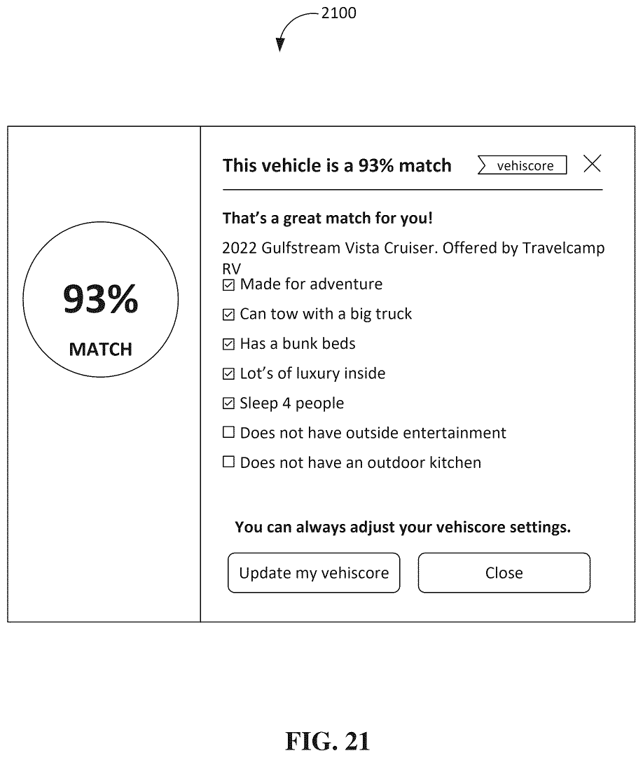

FIG. 21 is a screenshot of a user interface 2100 of the application for facilitating the personalizing shopping of the vehicles, in accordance with some embodiments. Further, the user interface displays details related to scoring and matching of the vehicle to the consumer.

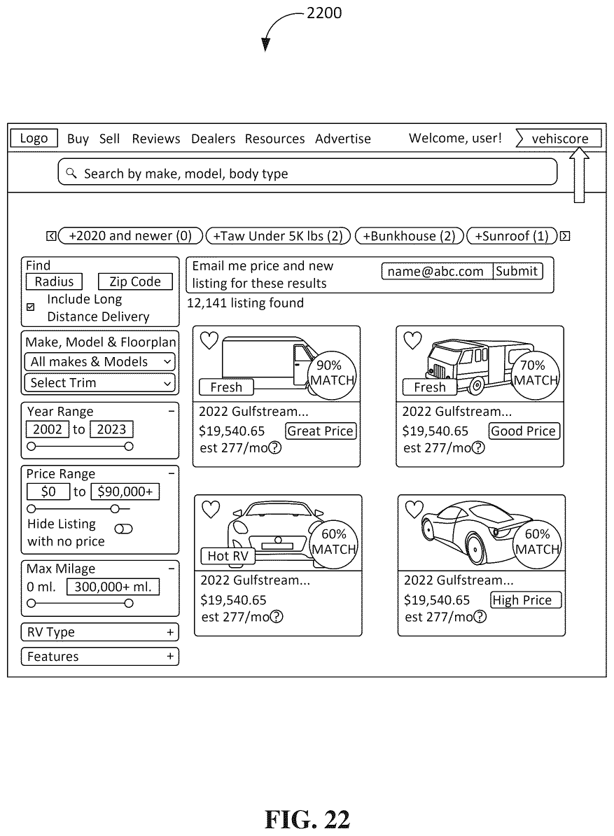

FIG. 22 is a screenshot of a user interface 2200 of the application for facilitating the personalized shopping of the vehicles, in accordance with some embodiments. Further, the user interface displays a vehiscore badge in the header.

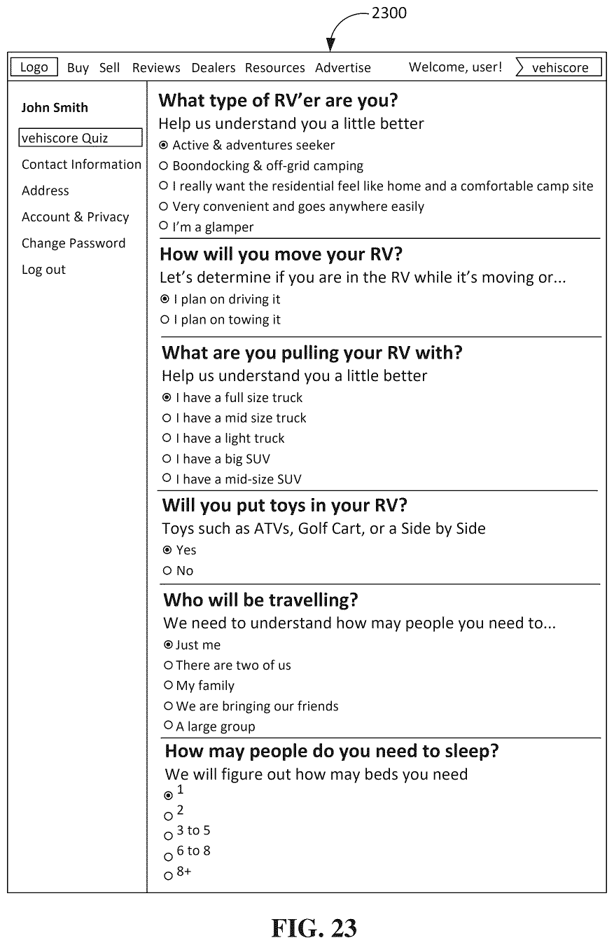

FIG. 23 is a screenshot of a user interface 2300 of the application for facilitating the personalized shopping of the vehicles, in accordance with some embodiments. Further, the user interface displays a list of the quiz questions along with the response of the consumer.

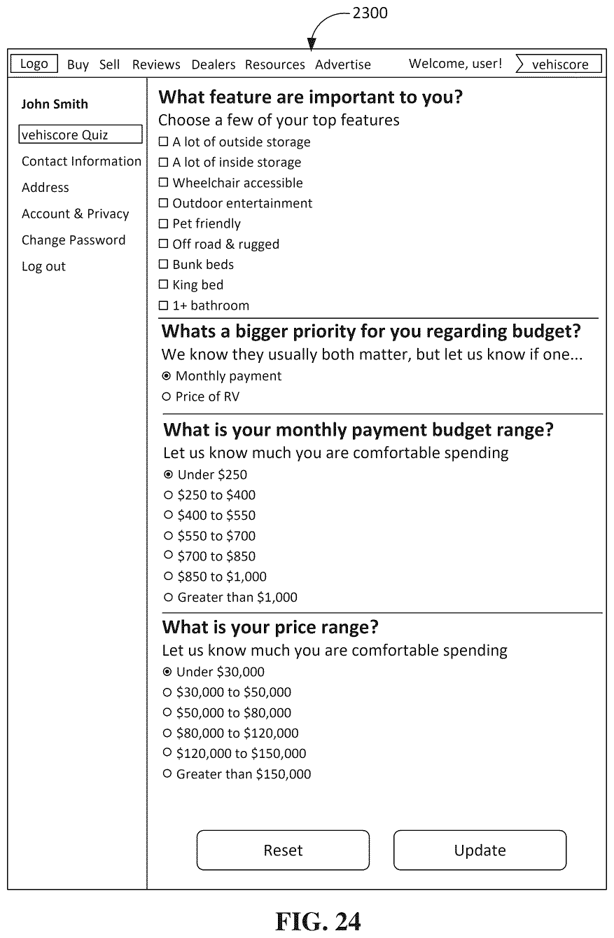

FIG. 24 is a continuation screenshot of the user interface 2300 of the application for facilitating the personalized shopping of the vehicles, in accordance with some embodiments.

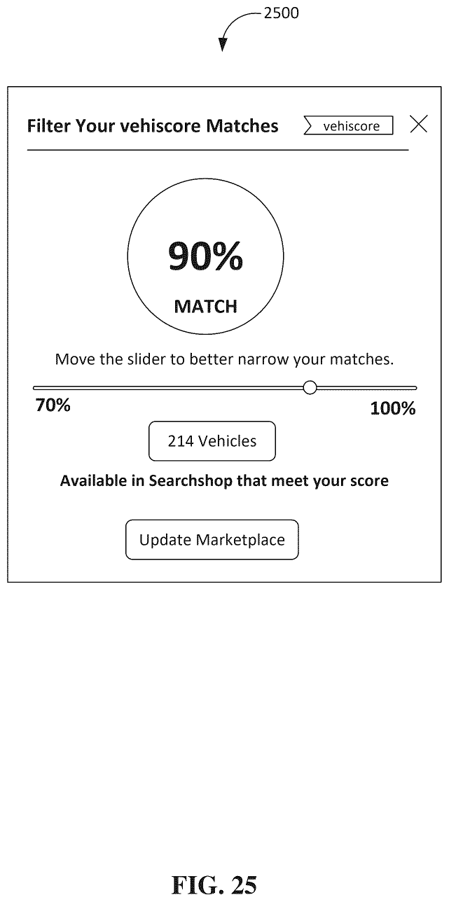

FIG. 25 is a screenshot of a user interface 2500 of the application for facilitating the personalized shopping of the vehicles, in accordance with some embodiments. Further, the user interface displays details about the availability of vehicles with respect to a specific vehiscore.

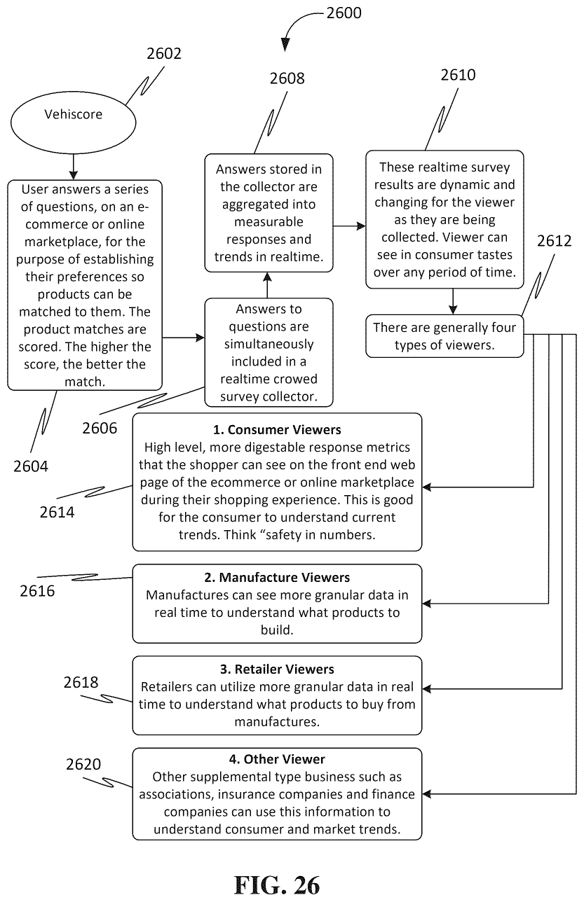

FIG. 26 is a flow diagram of an Integrated Shopper Crowd Surveying (ISCS) 2600 for facilitating personalized shopping of vehicles, in accordance with some embodiments. Further, the Integrated Shopper Crowd Surveying (ISCS) 2600 may include presenting questions in conjunction with a shopping experience in an e-commerce or online marketplace environment for the purpose of capturing real-time buying trends. Accordingly, at 2602 the ISCS 2600 may include a step of a user visiting searchshop.

Further, at 2604 the ISCS 2600 may include a step of the user answers a series of questions, on an e-commerce or online marketplace, for the purpose of establishing their preferences so products can be matched to them. Further, the product matches are scored. The higher the score, the better the match.

Further, at 2606 the ISCS 2600 may include a step of simultaneously including the answers to the questions in a real-time crowed survey collector.

Further, at 2608 the ISCS 2600 may include a step of storing the answers in the collector and aggregating the answers into measurable responses and trends in real time.

Further, at 2610 the ISCS 2600 may include real-time survey results. Further, the real-time survey results may be dynamic and changing for the viewer as they are being collected. Viewers can see consumer tastes over any period of time.

Further, at 2612 the ISCS 2600 may include presenting the results to four types of viewers. Further, the four types of viewers may include consumer viewers, manufacturer viewers, retailer viewers, and other viewers.

Further, at 2614 the ISCS 2600 may include presenting the results to consumer viewers. Further, the results may be presented to the consumer viewer with high-level, more digestible response metrics that the shopper can see on the front-end web page of the e-commerce or online marketplace during their shopping experience. This is good for the consumer to understand current trends. Think “safety in numbers.

Further, at 2616 the ISCS 2600 may include presenting the results to manufacture viewers. Further, the manufacturers can see more granular data in real-time to understand what products to build.

Further, at 2618 the ISCS 2600 may include presenting the results to retailer viewers. Further, the retailers can utilize more granular data in real-time to understand what products to buy from manufacturers.

Further, at 2620 the ISCS 2600 may include presenting the results to other viewers. Further, the other viewers comprise other supplemental type businesses such as associations, insurance companies, and finance companies that may use this information to understand consumer and market trends.

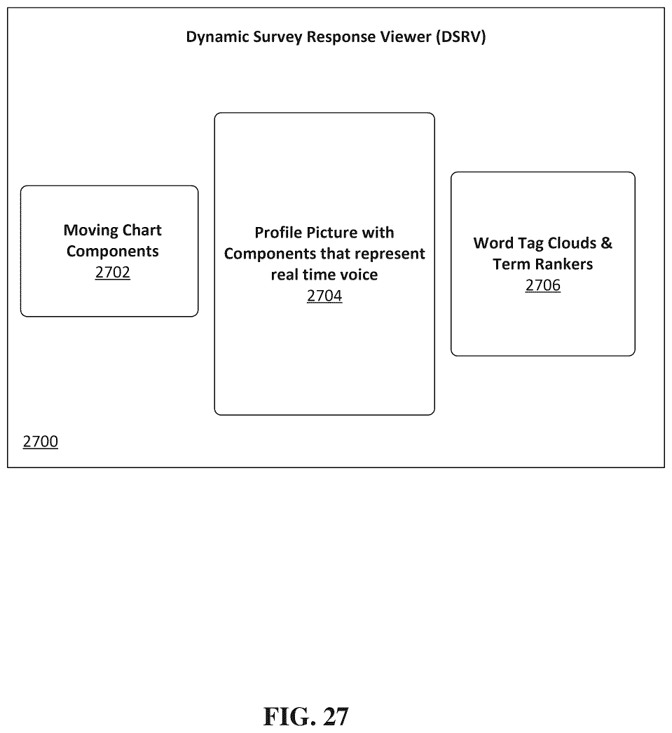

FIG. 27 is a block diagram of a dynamic survey response viewer 2700 for facilitating personalized shopping of vehicles, in accordance with some embodiments. Accordingly, the dynamic survey response viewer (DSRV) 2700 may be the main, overall component on the front end, that the viewer may use to see and understand the trends. Further, the DSRV 2700 may include three main following attributes/components. Further, the three main following attributes/components may include a plurality of moving chart component 2702, a profile picture with components that represent real-time voice 2704, and a world tag clouds and term rankers 2706.

Further, the plurality of moving chart component 2702 may include a moving progress bar component, trend lines, and other charting components. Further, the plurality of moving chart component 2702 may be moving in real-time on the page as user feedback is changing.

Further, the profile picture with components that represent real-time voice 2704 may include components configured for representing real-time voice. Further, the profile picture with components that represent real-time voice 2704 may include comments from real-time consumers and shoppers. Further, the real-time consumers may be submitting answers and providing comments, to the questions they are answering. Further, the answers and comments may be viewable in a floating or carousel-type experience if the Integrated Shopper Crowd Surveying (ISCS) viewer user chooses to click on the icon to see the real-time pics and comments. Other attributes of the consumer, shoppers answering questions such as “authority”, “rank” etc. may enable this level of ranking for consumers and shoppers using the ISCS platform.

Further, the Word tag clouds and term rankers 2706 may include lists (think good to bad). Further, the lists may include consumers and shoppers. Further, the consumers and shoppers may be submitting answers. Further, the answers may be available to ISCS viewer users based on choosing to click on the icon to see this information.

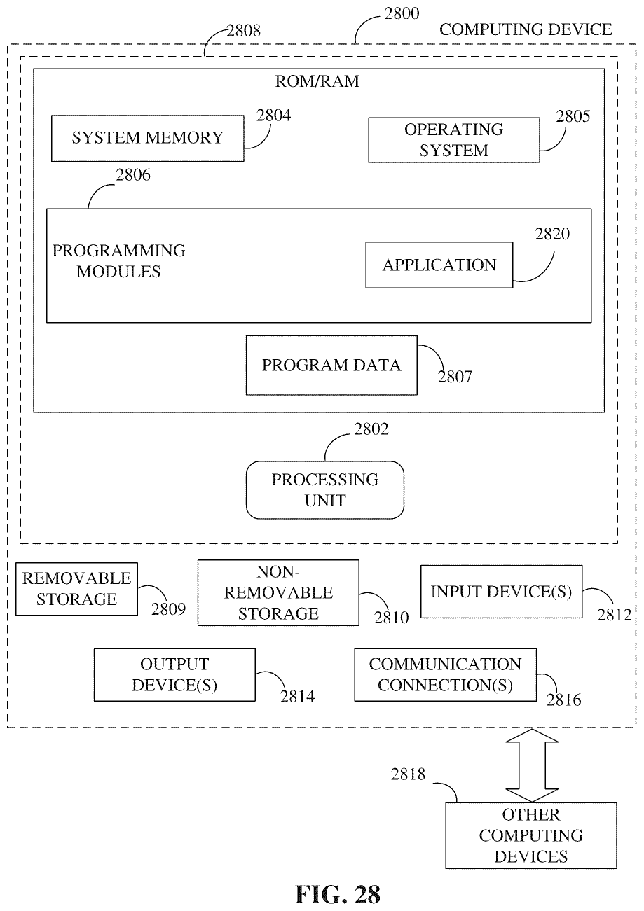

With reference to FIG. 28, a system consistent with an embodiment of the disclosure may include a computing device or cloud service, such as computing device 2800. In a basic configuration, computing device 2800 may include at least one processing unit 2802 and a system memory 2804. Depending on the configuration and type of computing device, system memory 2804 may comprise, but is not limited to, volatile (e.g. random-access memory (RAM)), non-volatile (e.g. read-only memory (ROM)), flash memory, or any combination. System memory 2804 may include operating system 2805, one or more programming modules 2806, and may include a program data 2807. Operating system 2805, for example, may be suitable for controlling computing device 2800's operation. In one embodiment, programming modules 2806 may include image-processing modules, machine learning modules, etc. Furthermore, embodiments of the disclosure may be practiced in conjunction with a graphics library, other operating systems, or any other application program and is not limited to any particular application or system. This basic configuration is illustrated in FIG. 28 by those components within a dashed line 2808.

Computing device 2800 may have additional features or functionality. For example, computing device 2800 may also include additional data storage devices (removable and/or non-removable) such as, for example, magnetic disks, optical disks, or tape. Such additional storage is illustrated in FIG. 28 by a removable storage 2809 and a non-removable storage 2810. Computer storage media may include volatile and non-volatile, removable, and non-removable media implemented in any method or technology for storage of information, such as computer-readable instructions, data structures, program modules, or other data. System memory 2804, removable storage 2809, and non-removable storage 2810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), other optical storage, magnetic cassettes, magnetic tape, magnetic disk storage or other magnetic storage devices, or any other medium which can be used to store information and which can be accessed by computing device 2800. Any such computer storage media may be part of device 2800. Computing device 2800 may also have input device(s) 2812 such as a keyboard, a mouse, a pen, a sound input device, a touch input device, a location sensor, a camera, a biometric sensor, etc. Output device(s) 2814 such as a display, speakers, a printer, etc. may also be included. The aforementioned devices are examples and others may be used.

Computing device 2800 may also contain a communication connection 2816 that may allow device 2800 to communicate with other computing devices 2818, such as over a network in a distributed computing environment, for example, an intranet or the Internet. Communication connection 2816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2804, including operating system 2805. While executing on processing unit 2802, programming modules 2806 (e.g., application 2820) may perform processes including, for example, one or more stages of methods, algorithms, systems, applications, servers, databases as described above. The aforementioned process is an example, and processing unit 2802 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of managing shopping of products by users, the method comprising:
transmitting, using a communication device, at least one questionnaire for scoring the products for at least one user to at least one user device associated with the at least one user;
receiving, using the communication device, at least one response for the at least one questionnaire from the at least one user device;
analyzing, using a processing device, the at least one response and the at least one questionnaire;
determining, using the processing device, at least one preference associated with the at least one user based on the analyzing of the at least one response and the at least one questionnaire;
obtaining, using the processing device, at least one product data associated with each of a plurality of products providable to the at least one user, wherein the at least one product data comprises at least one product information and at least one product characteristic of each of the plurality of products;
analyzing, using the processing device, the at least one product characteristic of each of the plurality of products based on the at least one preference;
determining, using the processing device, a degree of match for each of the plurality of products to the at least one user based on the analyzing of the at least one product characteristic, wherein the degree of match ranges from a minimum degree of match and a maximum degree of match;
generating, using the processing device, a product-preference score for each of the plurality of products based on the degree of match;
transmitting, using the communication device, the product-preference score corresponding to each of the plurality of products and the at least one product information of each of the plurality of products to the at least one user device; and
storing, using a storage device, the at least one preference.

2. The method of claim 1 further comprising:
obtaining, using the processing device, at least one user data associated with the at least one user;
analyzing, using the processing device, the at least one user data; and
generating, using the processing device, the at least one questionnaire based on the analyzing of the at least one user data.

3. The method of claim 1 further comprising:
determining, using the processing device, at least one characteristic of the at least one user based on the analyzing of the at least one response and the at least one questionnaire;
generating, using the processing device, at least one profile associated with the at least one user based on the at least one characteristic of the at least one user; and
storing, using the storage device, the at least one profile.

4. The method of claim 3 further comprising:
transmitting, using the communication device, at least one prompt for selectively sharing the at least one profile of the at least one user to the at least one user device, wherein the at least one prompt comprises a plurality of sharing options and a plurality of selection options corresponding to at least one selecting criterion;
receiving, using the communication device, at least one prompt response corresponding to the at least one prompt from the at least one user device, wherein the at least one prompt response comprises at least one sharing option indication corresponding to at least one of the plurality of sharing options and at least one selection option indication corresponding to at least one of the plurality selection options;
identifying, using the processing device, at least one product provider from a plurality of product providers based on the at least one prompt response; and
transmitting, using the communication device, the at least one profile to at least one product provider device associated with the at least one product provider.

5. The method of claim 4 further comprising:
analyzing, using the processing device, the product-preference score for each of the plurality of products based on at least one criterion; and
identifying, using the processing device, a plurality of first products from the plurality of products based on the analyzing of the product-preference score for each of the plurality of products, wherein the plurality of first products is provided by the at least one product provider, wherein the identifying of the at least one product provider from the plurality of product providers is further based on the identifying of the plurality of first products.

6. The method of claim 4 further comprising:
receiving, using the communication device, at least one information from the at least one product provider device associated with the at least one product provider;
analyzing, using the processing device, the at least one information;
selecting, using the processing device, a number of first products from the plurality of first products based on the analyzing of the at least one information and the at least one profile;
generating, using the processing device, at least one deal for providing the number of first products to the at least one user by the at least one product provider based on the selecting and the analyzing of the at least one information;
obtaining, using the processing device, the product-preference score for each of the number of first products and the at least one product information associated with the number of first products based on the selecting; and
transmitting, using the communication device, the product-preference score for each of the number of first products, the at least one product information associated with the number of first products, and the at least one deal for the providing of the number of first products to the at least one user device.

7. The method of claim 1 further comprising:
receiving, using the communication device, at least one request from the at least one user device;
updating, using the processing device, the at least one response for the at least one questionnaire;
generating, using the processing device, at least one updated response for the at least one questionnaire; and
analyzing, using the processing device, the at least one updated response, wherein the generating of the at least one preference is further based on the analyzing of the at least one updated response.

8. The method of claim 1, wherein the at least one questionnaire comprises a plurality of questions for the scoring of the products, wherein the at least one response comprises at least one answer corresponding to at least one of the plurality of questions, wherein the analyzing of the at least one response and the at least one questionnaire comprises analyzing the at least one answer corresponding to at least one of the plurality of questions and the plurality of questions using at least one machine learning model, wherein the determining of the at least one preference is further based on the analyzing of the at least one answer corresponding to at least one of the plurality of questions and the plurality of questions using the at least one machine learning model.

9. The method of claim 1 further comprising:
identifying, using the processing device, at least one answered question from a plurality of questions comprised in the at least one questionnaire and at least one unanswered question from the plurality of questions based on the at least one response, wherein the plurality of questions comprises the at least one answered question and the at least one unanswered question, wherein the at least one response corresponds to the at least one answered question;
obtaining, using the processing device, at least one data for the at least one unanswered question;
analyzing, using the processing device, the at least one data, the at least one unanswered question, and at least one of the at least one response and the at least one answered question using at least one generative machine learning model;
generating, using the processing device, at least one first response corresponding to the at least one unanswered question using the at least one generative machine learning model; and
analyzing, using the processing device, the at least one first response corresponding to the at least one unanswered question and the at least one unanswered question, wherein the analyzing of the at least one response and the at least one questionnaire comprises analyzing the at least one response and the at least one answered question, wherein the determining of the at least one preference is further based on the analyzing of the at least one response and the at least one answered question and the analyzing of the at least one first response and the at least one unanswered question.

10. The method of claim 1, wherein the at least one user device comprises at least one sensor, wherein the at least one sensor is configured for generating at least one sensor data based on detecting at least one of a physical state, a physiological state, and a biometric of the at least one user, wherein the at least one response comprises the at least one sensor data.

11. A system for managing shopping of products by users, the system comprising:
a communication device configured for:
transmitting at least one questionnaire for scoring the products for at least one user to at least one user device associated with the at least one user;
receiving at least one response for the at least one questionnaire from the at least one user device; and
transmitting a product-preference score corresponding to each of a plurality of products and at least one product information of each of the plurality of products to the at least one user device;
a processing device communicatively coupled with the communication device, wherein the processing device is configured for:
analyzing the at least one response and the at least one questionnaire;
determining at least one preference associated with the at least one user based on the analyzing of the at least one response and the at least one questionnaire;
obtaining at least one product data associated with each of the plurality of products providable to the at least one user, wherein the at least one product data comprises the at least one product information and at least one product characteristic of each of the plurality of products;
analyzing the at least one product characteristic of each of the plurality of products based on the at least one preference;
determining a degree of match for each of the plurality of products to the at least one user based on the analyzing of the at least one product characteristic, wherein the degree of match ranges from a minimum degree of match and a maximum degree of match; and
generating the product-preference score for each of the plurality of products based on the degree of match; and
a storage device communicatively coupled with the processing device, wherein the storage device is configured for storing the at least one preference.

12. The system of claim 11, wherein the processing device is further configured for:
obtaining at least one user data associated with the at least one user;
analyzing the at least one user data; and
generating the at least one questionnaire based on the analyzing of the at least one user data.

13. The system of claim 11, wherein the processing device is further configured for:
determining at least one characteristic of the at least one user based on the analyzing of the at least one response and the at least one questionnaire; and
generating least one profile associated with the at least one user based on the at least one characteristic of the at least one user, wherein the storage device is further configured for storing at least one profile.

14. The system of claim 13, wherein the communication device is further configured for:
transmitting at least one prompt for selectively sharing the at least one profile of the at least one user to the at least one user device, wherein the at least one prompt comprises a plurality of sharing options and a plurality of selection options corresponding to at least one selecting criterion;
receiving at least one prompt response corresponding to the at least one prompt from the at least one user device, wherein the at least one prompt response comprises at least one sharing option indication corresponding to at least one of the plurality of sharing options and at least one selection option indication corresponding to at least one of the plurality selection options; and
transmitting the at least one profile to at least one product provider device associated with at least one product provider, wherein the processing device is further configured for identifying the at least one product provider from a plurality of product providers based on the at least one prompt response.

15. The system of claim 14, wherein the processing device is further configured for:
analyzing the product-preference score for each of the plurality of products based on at least one criterion; and
identifying a plurality of first products from the plurality of products based on the analyzing of the product-preference score for each of the plurality of products, wherein the plurality of first products is provided by the at least one product provider, wherein the identifying of the at least one product provider from the plurality of product providers is further based on the identifying of the plurality of first products.

16. The system of claim 14, wherein the communication device is further configured for:
receiving at least one information from the at least one product provider device associated with the at least one product provider; and
transmitting the product-preference score for each of a number of first products, the at least one product information associated with the number of first products, and at least one deal for the providing of the number of first products to the at least one user device, wherein the processing device is further configured for:
analyzing the at least one information;
selecting the number of first products from the plurality of first products based on the analyzing of the at least one information and the at least one profile;
generating the at least one deal for providing the number of first products to the at least one user by the at least one product provider based on the selecting and the analyzing of the at least one information; and
obtaining the product-preference score for each of the number of first products and the at least one product information associated with the number of first products based on the selecting.

17. The system of claim 11, wherein the communication device is further configured for receiving at least one request from the at least one user device, wherein the processing device is further configured for:
updating the at least one response for the at least one questionnaire;
generating at least one updated response for the at least one questionnaire; and
analyzing the at least one updated response, wherein the generating of the at least one preference is further based on the analyzing of the at least one updated response.

18. The system of claim 11, wherein the at least one questionnaire comprises a plurality of questions for the scoring of the products, wherein the at least one response comprises at least one answer corresponding to at least one of the plurality of questions, wherein the analyzing of the at least one response and the at least one questionnaire comprises analyzing the at least one answer corresponding to at least one of the plurality of questions and the plurality of questions using at least one machine learning model, wherein the determining of the at least one preference is further based on the analyzing of the at least one answer corresponding to at least one of the plurality of questions and the plurality of questions using the at least one machine learning model.

19. The system of claim 11, wherein the processing device is further configured for:
identifying at least one answered question from a plurality of questions comprised in the at least one questionnaire and at least one unanswered question from the plurality of questions based on the at least one response, wherein the plurality of questions comprises the at least one answered question and the at least one unanswered question, wherein the at least one response corresponds to the at least one answered question;
obtaining at least one data for the at least one unanswered question;
analyzing the at least one data, the at least one unanswered question, and at least one of the at least one response and the at least one answered question using at least one generative machine learning model;
generating at least one first response corresponding to the at least one unanswered question using the at least one generative machine learning model; and
analyzing the at least one first response corresponding to the at least one unanswered question and the at least one unanswered question, wherein the analyzing of the at least one response and the at least one questionnaire comprises analyzing the at least one response and the at least one answered question, wherein the determining of the at least one preference is further based on the analyzing of the at least one response and the at least one answered question and the analyzing of the at least one first response and the at least one unanswered question.

20. The system of claim 11, wherein the at least one user device comprises at least one sensor, wherein the at least one sensor is configured for generating at least one sensor data based on detecting at least one of a physical state, a physiological state, and a biometric of the at least one user, wherein the at least one response comprises the at least one sensor data.
